(19) United States
(12) Patent Application Publication
(10) Pub. No.: US 2026/0260226 A1
(43) Pub. Date: Sep. 3, 2026

(54) RELAY DEVICE FOR POS SYSTEM, POS SYSTEM, AND SERVER FOR POS SYSTEM

(71) Applicant: SEIKO EPSON CORPORATION, Tokyo (JP)

(72) Inventors: Junichi YOSHIZAWA, MATSUMOTO-SHI (JP); Hiroyasu FUKAZAWA, MATSUMOTO-SHI (JP); Koji HASHIMOTO, MATSUMOTO-SHI (JP); Yasuhiro OSHIMA, MATSUMOTO-SHI (JP); Hiroki MURAYAMA, AZUMINO-SHI (JP); Takaaki TANIGUCHI, SHIOJIRI-SHI (JP)

(21) Appl. No.: 19/549,215

(22) Filed: Feb. 25, 2026

(30) Foreign Application Priority Data
Feb. 28, 2025 (JP) 2025-032090

(51) Int. Cl. G06Q 20/20; H04W 24/08

(52) U.S. Cl. CPC G06Q 20/202; H04W 24/08

(57) ABSTRACT

A relay device 12 of a POS system 11 is configured to relay communication between a terminal device 15 capable of executing an accounting process and one or more peripheral devices 30. The relay device 12 includes: a transmission unit 56 for transmitting request information to any one of the peripheral devices 30; and a reception unit 57 for receiving response information from any one of the peripheral devices 30. The relay device 12 includes: an analysis unit 62 for analyzing analysis target information to be analyzed among the request information and the response information; and a determination unit 63 for determining the state of any of the peripheral devices 30 based on the analysis result of the analysis unit 62.

The present application is based on, and claims priority from JP Application Serial Number 2025-032090, filed February 28, 2025, the disclosure of which is hereby incorporated by reference herein in its entirety.

### BACKGROUND

### Technical Field

The present disclosure relates to a relay device for POS system, a POS system, a server for POS system, and a maintenance method for POS system for relaying a terminal device for performing an accounting process and a peripheral device.

### Related Art

For example, JP-A-2005-84759 discloses a maintenance system in which a user can construct a POS terminal device by combining desired peripheral devices to introduce and maintain a POS system. This POS system refers to a setting file that defines combinations of models of peripheral devices of different types, thereby determining whether a combination of models of peripheral devices input by an input unit is valid.

JP-A-2005-84759 is an example of the related art.

However, in addition to the maintenance of constructing the POS system by an appropriate combination of models of peripheral devices, maintenance of recovering the POS system when a failure occurs is performed as well. For early recovery of the POS system, it is important to quickly elucidate the cause of the failure. There is a demand for further improvement in efficient maintenance of peripheral devices constituting a POS system.

### SUMMARY

A relay device for POS system for solving the above-described problem is a relay device for POS system configured to relay communication between a terminal device configured to execute an accounting process and one or more peripheral devices. The relay device includes: a transmission unit configured to transmit request information to any of the peripheral devices; a reception unit configured to receive response information from any of the peripheral devices; an analysis unit configured to analyze analysis target information to be analyzed among the request information and the response information; and a determination unit configured to determine a state of any of the peripheral devices based on an analysis result of the analysis unit.

A POS system for solving the above-described problem includes: a relay device configured to relay between a terminal device configured to execute an accounting process and one or more peripheral devices; and a server configured to be connected to the relay device via a network. The relay device includes: a transmission unit configured to transmit request information to any of the peripheral devices; and a reception unit configured to receive response information from any of the peripheral devices. The relay device or the server includes: an analysis unit configured to analyze analysis target information to be analyzed among the request information and the response information; and a determination unit configured to determine a state of any of the peripheral devices based on an analysis result of the analysis unit.

A server for POS system for solving the above-described problem is a server for, in a POS system including a terminal device configured to execute an accounting process and one or more peripheral devices, being communicably connected to a relay device configured to relay the terminal device and the peripheral devices. The relay device includes: a transmission unit configured to transmit request information to any of the peripheral devices; and a reception unit configured to receive response information from any of the peripheral devices. The server includes: an analysis unit configured to analyze analysis target information to be analyzed among the request information and the response information; and a determination unit configured to determine a state of any of the peripheral devices based on an analysis result of the analysis unit.

A maintenance method in a POS system for solving the above-described problem is a maintenance method for POS system for maintaining one or more peripheral devices in a POS system including a terminal device configured to execute an accounting process and the peripheral devices. The POS system includes a relay device configured to relay the terminal device and the peripheral devices. The relay device includes: a transmission unit configured to transmit request information to any of the peripheral devices; and a reception unit configured to receive response information from any of the peripheral devices. The method includes: analyzing analysis target information to be analyzed among the request information and the response information; acquiring maintenance information available for maintenance of the peripheral devices based on an analysis result of the analysis target information; and causing an output unit of a device configured to communicate with the relay device to output the maintenance information.

A maintenance method for POS system for solving the above-described problem is a maintenance method for a POS system including a terminal device configured to execute an accounting process and one or more peripheral devices. The POS system includes a relay device configured to relay the terminal device and the peripheral devices. The relay device includes: a communication unit configured to be communicably connected to a server or a maintenance terminal; a transmission unit configured to transmit request information to any of the peripheral devices; and a reception unit configured to receive response information from any of the peripheral devices. The method includes: analyzing analysis target information to be analyzed among the request information and the response information; detecting an abnormality of any of the peripheral devices based on an analysis result of the analysis target information; and, upon detecting the abnormality, notifying the server or the maintenance terminal of information indicating that the peripheral device is abnormal.

A maintenance method for POS system for solving the above-described problem is a maintenance method for a POS system including a terminal device configured to execute an accounting process and one or more peripheral devices. The POS system includes a relay device configured to relay the terminal device and the peripheral devices. The relay device includes: a communication unit configured to be communicably connected to a server or a maintenance terminal; a transmission unit configured to transmit request information to any of the peripheral devices; and a reception unit configured to receive response information from any of the peripheral devices. At least one of the peripheral devices is a printing device. The maintenance method includes: upon detecting an abnormality of the printing device based on an analysis result obtained by analyzing analysis target information to be analyzed among the request information and the response information, notifying the server or the maintenance terminal of information indicating an abnormality; upon receiving a maintenance request for the printing device from the server or the maintenance terminal, issuing a maintenance command corresponding to the maintenance request and transmitting the maintenance command to the printing device; the printing device performing a maintenance process instructed by the maintenance command; and, upon receiving outcome information on the maintenance process or completion information on the maintenance process from the printing device, sending the outcome information or the completion information to the server or the maintenance terminal.

### BRIEF DESCRIPTION OF THE DRAWINGS

FIG. 1 is a schematic diagram illustrating a POS system according to a first embodiment.

FIG. 2 is a schematic diagram illustrating functions of the POS system according to the first embodiment.

FIG. 3 is a flowchart illustrating an activation control process according to the first embodiment.

FIG. 4 is a flowchart illustrating a peripheral device identification process according to the first embodiment.

FIG. 5 is a flowchart illustrating an accounting control process according to the first embodiment.

FIG. 6 is a flowchart illustrating the accounting control process according to the first embodiment.

FIG. 7 is a flowchart illustrating the accounting control process according to the first embodiment.

FIG. 8 is a flowchart illustrating the accounting control process according to the first embodiment.

FIG. 9 is a flowchart illustrating a state determination / failure detection process according to the first embodiment.

FIG. 10 is a flowchart illustrating the accounting control process according to the first embodiment.

FIG. 11 is a flowchart illustrating the accounting control process according to the first embodiment.

FIG. 12 is a flowchart illustrating a simple log generation process according to the first embodiment.

FIG. 13 is a flowchart illustrating a detailed log acquisition process according to the first embodiment.

FIG. 14 is a flowchart illustrating a firmware update process according to the first embodiment.

FIG. 15 is a schematic diagram illustrating functions of a POS system according to a second embodiment.

FIG. 16 is a flowchart illustrating a peripheral device identification process according to the second embodiment.

FIG. 17 is a flowchart illustrating an accounting control process according to the second embodiment.

FIG. 18 is a flowchart illustrating the accounting control process according to the second embodiment.

FIG. 19 is a flowchart illustrating the accounting control process according to the second embodiment.

FIG. 20 is a flowchart illustrating the accounting control process according to the second embodiment.

FIG. 21 is a schematic diagram illustrating functions of a POS system of a first example according to a third embodiment.

FIG. 22 is a schematic diagram illustrating functions of a POS system of a second example according to the third embodiment.

FIG. 23 is a flowchart illustrating a state determination / failure detection process according to the third embodiment.

FIG. 24 is a schematic diagram illustrating functions of a modification of the POS system according to the first embodiment.

FIG. 25 is a schematic diagram illustrating functions of a modification of the POS system according to the first embodiment different from FIG. 24.

FIG. 26 is a schematic diagram illustrating functions of a modification of the POS system according to the first embodiment different from FIG. 25.

FIG. 27 is a schematic diagram illustrating functions of a modification of the POS system according to the second embodiment.

FIG. 28 is a schematic diagram illustrating the functions of the POS system in cooperation with an order entry system according to a modification.

### DESCRIPTION OF EMBODIMENTS

### First Embodiment

Hereinafter, an embodiment of a relay device for POS system, a POS system, a control method for POS system, and a program will be described.

### Configuration of POS System 11

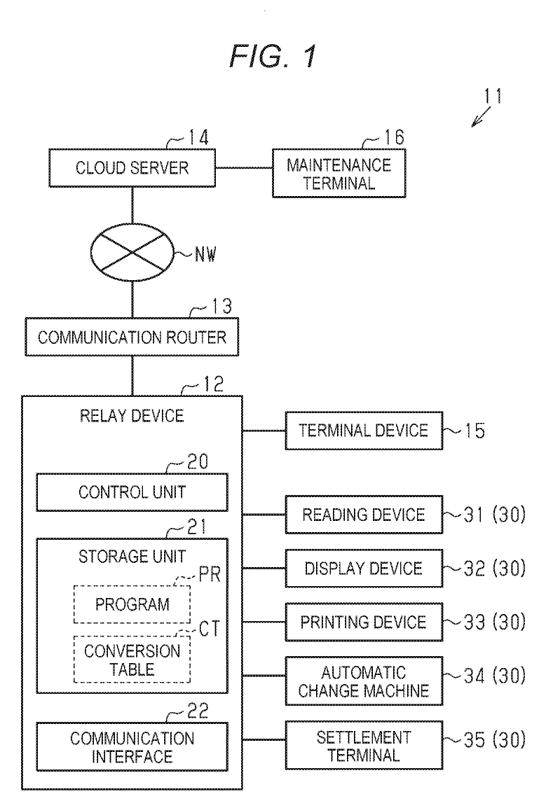

As illustrated in FIG. 1, a Point of Sale (POS) system 11 manages point-of-sale information. The POS system 11 causes at least one peripheral device 30 to perform an accounting process using a terminal device 15. The POS system 11 includes the terminal device 15, one or more peripheral devices 30, and a relay device 12. The relay device 12 is configured to relay communication between the terminal device 15 and the one or more peripheral devices 30. The POS system 11 may include a plurality of terminal devices 15.

The terminal device 15 is a device that allows an operator to perform input related to the accounting process. The terminal device 15 is a device for receiving input by a store clerk, but may be, for example, a device for receiving input by a purchaser of a commodity. The terminal device 15 is a portable terminal device (mobile terminal device), but is not limited thereto, and may be a device that is not easy to carry. The portable terminal device may be, for example, a tablet terminal device. The terminal device 15 that is not easy to carry may be, for example, a POS terminal device.

The terminal device 15 is installed with an operating system and an application. The operating system may be any operating system. The application may be software compatible with the installed operating system. The application is developed by a software development kit (SDK) so as to be compatible with the operating system. The application is a POS application for using the POS system 11.

The terminal device 15 can control the peripheral device 30 using a common command. The common command is generated in the same manner regardless of the operating system and the application installed in the terminal device 15.

As a specific example, a plurality of terminal devices 15 generate common commands in the same manner even if the installed operating systems and applications are different.

The POS system 11 includes at least one peripheral device 30. The POS system 11 may include a plurality of peripheral devices 30. The At least one peripheral device 30 may include a device classified into any of a plurality of categories. Specifically, the at least one peripheral device 30 may include at least any one of a reading device 31, a display device 32, a printing device 33, an automatic change machine 34, and a settlement terminal 35. The plurality of categories may be any of the reading device 31, the display device 32, the printing device 33, the automatic change machine 34, and the settlement terminal 35. The at least one of the peripheral devices 30 may be the printing device 33.

The reading device 31 is configured to read information on a commodity. The reading device 31 reads a commodity identifier for identifying the commodity. The reading device 31 may read various codes for identifying the commodity. The reading device 31 may be a barcode reader for reading a barcode for identifying the commodity. One POS system 11 may include a plurality of reading devices 31.

The display device 32 is configured to perform display related to the accounting process. The display device 32 may be configured to display a subtotal in the accounting process. The display device 32 may be configured to perform settlement display in the accounting process. The display device 32 may be a customer display.

The printing device 33 is configured to perform printing related to accounting. The printing device 33 may be configured to print a receipt related to accounting. The printing device 33 may be configured to print a service coupon related to accounting. The printing device 33 may use any printing method. The printing device 33 performs printing by a thermal method, but may perform printing by any printing method.

The automatic change machine 34 is configured to perform cash settlement. The automatic change machine 34 allows cash to be inserted. The automatic change machine 34 receives the inserted cash. The automatic change machine 34 is configured to discharge cash for change after settlement.

The settlement terminal 35 is a device for performing settlement for accounting. The settlement terminal 35 is a device for performing electronic settlement. The settlement terminal 35 may be a device for performing electronic settlement by any settlement method. The settlement terminal 35 may be a device for performing credit card settlement. The settlement terminal 35 may be a device for performing code settlement.

As described above, the peripheral device 30 is a device related to the accounting process and is classified by category. The plurality of peripheral devices 30 may be devices manufactured by different manufacturers or may be devices manufactured by the same manufacturer.

The plurality of peripheral devices 30 have different commands when communicating with the terminal device 15, but may have the same command. In this way, the plurality of peripheral devices 30 may be controlled by unique commands. That is, the plurality of peripheral devices 30 may have different unique commands.

The POS system 11 includes a relay device 12. That is, the relay device 12 is the relay device 12 of the POS system 11. The POS system 11 may include a communication router 13.

The relay device 12 can be connected to at least one peripheral device 30. The relay device 12 can be connected to a plurality of peripheral devices 30. The relay device 12 may perform serial communication with a plurality of peripheral devices 30. The relay device 12 may be capable of communicating with a plurality of peripheral devices 30 via a universal serial bus (USB). The relay device 12 may perform parallel communication with a plurality of peripheral devices 30.

Here, the number of peripheral devices 30 belonging to the POS system 11 is N (N is a natural number). In the present embodiment, the relay device 12 is connected to N peripheral devices 30. However, the configuration is not limited to the configuration in which all of the N peripheral devices 30 are connected to the relay device 12, and M among the N peripheral devices 30 may be directly connected to the terminal device 15. Among the N peripheral devices 30, M peripheral devices 30 that use a command common to the terminal device 15 may be directly connected to the terminal device 15. M is a natural number of 1 or more and (N - 1) or less. That is, M is a natural number satisfying 0 < M < N.

As an example, the reading device 31 may be directly connected to the terminal device 15. If the terminal device 15 is a tablet terminal device that can be carried by a store clerk, a store clerk moving in the store may be capable of carrying the reading device 31 together. The reading device 31 may be configured to communicate with the terminal device 15. The reading device 31 may perform wireless communication or wired communication with the terminal device 15. The reading device 31 may perform near field communication with the terminal device 15. The reading device 31 may communicate with the terminal device 15 via Bluetooth (registered trademark). The reading device 31 may be provided in the terminal device 15.

In the present embodiment, as an example, the reading device 31 is also connected to the relay device 12. The reading device 31 may be wirelessly connected to the relay device 12 in a manner enabling wireless communication. Thus, the store clerk moving in the store may carry a reading device 31 of a handy type together with the terminal device 15 configured with a tablet terminal device.

The relay device 12 includes a control unit 20, a storage unit 21, and a communication interface 22. The control unit 20 controls the relay device 12. The control unit 20 may be at least one computer for executing various processes according to a computer program. The control unit 20 may include one or more processors that execute various processes according to a computer program.

The control unit 20 may include one or more dedicated hardware circuits. The control unit 20 may include an application specific integrated circuit that executes at least some of the various kinds of processing. The control unit 20 may include a circuit including a combination of a processor and a hardware circuit. The processor includes a CPU and memories such as a RAM and a ROM. The memories store program codes or commands configured to cause the CPU to execute processing. A memory, that is, a computer-readable medium includes all readable media that can be accessed by a general-purpose or dedicated computer.

The storage unit 21 may store a program PR executed by the control unit 20. The storage unit 21 stores data set by the control unit 20. The storage unit 21 may include a hard disk, a flash memory, or the like. The storage unit 21 may include a RAM. The storage unit 21 may be provided in the control unit 20. The communication interface 22 is an interface for communicating with an external device. The relay device 12 according to the first embodiment has a command conversion function. In a relay device 12 having such a command conversion function, a conversion table CT to be referred to at the time of command conversion may be stored in the storage unit 21.

The relay device 12 can communicate with the terminal device 15. The relay device 12 can communicate with a cloud server 14 to be described later, which is an example of a server, via the communication router 13.

The communication router 13 is arranged near the relay device 12 separately from the relay device 12, but may be incorporated in the relay device 12. The communication router 13 is communicably connected to the relay device 12.

The communication router 13 is a router capable of both wired communication and wireless communication, but may be a router capable of either wired communication or wireless communication. The communication router 13 is connected to the relay device 12 in a manner enabling wired communication, but may be connected to the relay device 12 in a manner enabling wireless communication.

The communication router 13 performs wireless communication with the terminal device 15, but may perform wired communication with the terminal device 15. The communication router 13 performs wired communication with the cloud server 14, but may perform wireless communication with the cloud server 14.

The terminal device 15 may be configured not to perform wireless communication and wired communication with the communication router 13. In this case, the relay device 12 may have a tethering function. The terminal device 15 may be connected to the relay device 12 to communicate with the cloud server 14 via a network NW by tethering. The relay device 12 enables communication between the terminal device 15 and the peripheral device 30 by the command conversion function. Hereinafter, regarding the communication via the communication router 13, the description of the communication router 13 will be omitted.

The POS system 11 may include the cloud server 14. The cloud server 14 may be a maintenance server for maintaining the POS system 11 when a failure occurs. If the cloud server 14 is a maintenance server, the cloud server 14 is communicably connected to a maintenance terminal 16 managed by a maintenance person. The maintenance person may be a maintenance person of the store, a field engineer belonging to the maintenance service provider company contracted with the store, or the like.

In general, the POS system 11 mainly have the following two maintenance contract forms.

One is on-site maintenance service. When a failure occurs, an engineer of the maintenance service provider company goes from a service station to the store and repairs the POS system 11. First, a support center or a call center receives the content of the failure and arranges the engineer. Upon receiving the failure, it is difficult to grasp the accurate failure status of the POS system 11. Further, the on-site maintenance service does not allow time to be spent on failure analysis. As a result, the field engineer rushes to the site without knowing the failure status. In many cases, the field engineer brings various maintenance machines (from POS terminal to various peripheral devices) to the site and replaces the devices installed at the site to perform recovery. At this time, the field engineer replaces the devices one by one while performing trial and error, which takes time to recover from the failure and increases the sales opportunity loss of the store. In addition, the field engineer needs to rush to the site each time regardless of the actual failure situation, resulting in a very heavy burden of cost and man-hours on the maintenance company.

The other is send-back maintenance service. When a failure occurs, the peripheral device 30 failed is sent from the store side to a service station or a repair center of the maintenance service provider company. The sent failed peripheral device 30 is ordered for repair by the maintenance service provider company or the peripheral device manufacturer, and is returned to the store after the repair is completed. Send back maintenance does not need a field engineer to go to the site and thus has an advantage of low maintenance cost. However, it requires to specify the device under failure and send the device to a repair center or the like from the store side, which makes it difficult to take appropriate measures unless an engineer having advanced IT skills is resident on the store side. Therefore, the actual situation is that send-back maintenance cannot be effectively utilized except for shopping malls, large supermarkets, and the like.

In order to solve this type of problem, the POS system 11 of the present embodiment has a function of, when a failure occurs, collecting and providing maintenance information useful for resolving the failure from the POS system 11. The POS system 11 according to the present embodiment also has a function of detecting a failure and notifying the cloud server 14 or the maintenance terminal 16 of the abnormality of failure occurrence. The POS system 11 according to the present embodiment also has a maintenance function of performing simple maintenance processes on the peripheral device 30 by remote control from the cloud server 14 or the maintenance terminal 16. The cloud server 14 in the present embodiment is a maintenance server for executing processes related to the maintenance of the POS system 11.

The cloud server 14 may also serve as a server for managing commodity data. In this case, as the commodity data, the cloud server 14 may manage at least a commodity identifier, a commodity name, and a price in association. The cloud server 14 may be a server for managing data related to an accounting process. The cloud server 14 may be a server for managing data related to the specifications of the peripheral device 30. The server for managing commodity data may be a server separate from the cloud server 14, which is the maintenance server (another cloud server).

The cloud server 14, the terminal device 15, and the peripheral device 30 are configured in the same manner as the relay device 12. The cloud server 14, the terminal device 15, and the peripheral device 30 have the same configuration as the control unit 20, the storage unit 21, and the communication interface 22 of the relay device 12. Hereinafter, the control contents of the cloud server 14, the terminal device 15, and the peripheral device 30 will be described as the cloud server 14, the terminal device 15, and the peripheral device 30 while omitting a detailed description of the control entity.

### Functions of POS System 11

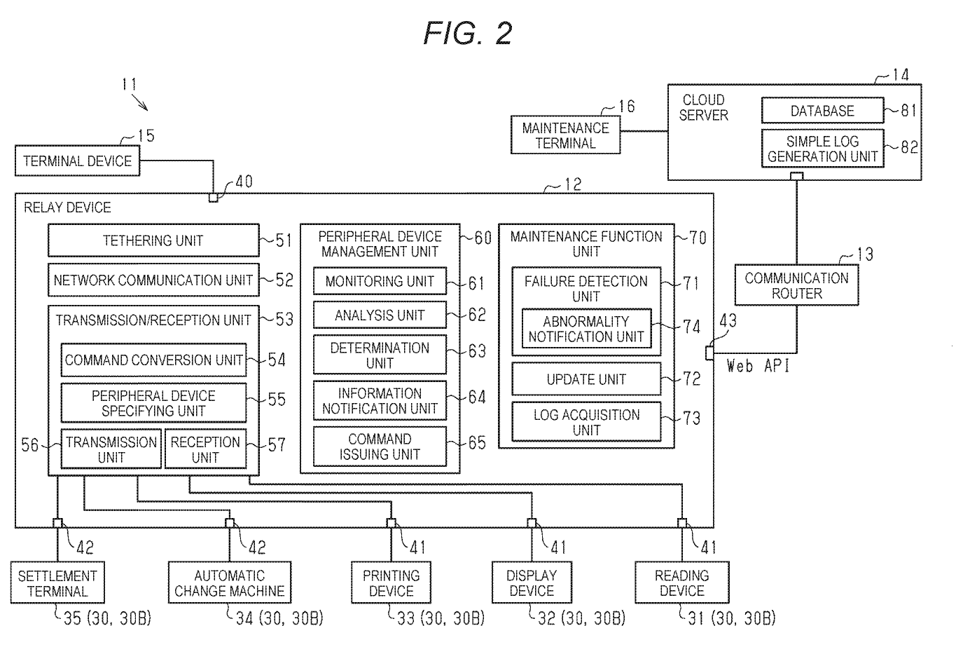

As illustrated in FIG. 2, in the POS system 11, the relay device 12 has various functions. The relay device 12 may have a function of detecting the peripheral device 30. The relay device 12 detects a connected peripheral device 30. The relay device 12 acquires a peripheral device identifier of the peripheral device 30 whose connection has been detected. The peripheral device identifier is data for identifying the peripheral device 30. Specifically, the peripheral device identifier is data for identifying the category of the peripheral device 30 and the type of the peripheral device 30.

The relay device 12 has a function of control relay between the terminal device 15 and the peripheral device 30. The relay device 12 performs control to allow communication with the terminal device 15. The relay device 12 performs control to allow communication with the cloud server 14. The relay device 12 functions as a switching hub with the peripheral device 30. The relay device 12 performs exclusive control on the plurality of peripheral devices 30.

In particular, the relay device 12 can be connected to a plurality of peripheral devices 30 classified into the same category. The relay device 12 can be connected to any one of the plurality of peripheral devices 30 classified into the same category.

The relay device 12 has a function of data conversion between the terminal device 15 and the peripheral device 30. The relay device 12 performs communication with the terminal device 15 using a common command. The relay device 12 performs communication with the peripheral device 30 using a unique command.

The storage unit 21 may store a conversion table CT. The conversion table CT is data for converting the unique command and the common command corresponding to the peripheral device identifier of the peripheral device 30. The control unit 20 refers to the conversion table CT and performs conversion between the common command and the unique command.

Upon receiving the common command from the terminal device 15, the relay device 12 converts the received common command into a unique command of the peripheral device 30 as the communication target. The relay device 12 transmits the converted unique command to the peripheral device 30 as the communication target.

Upon receiving the unique command from the peripheral device 30, the relay device 12 converts the received unique command into a common command. The relay device 12 transmits the converted common command to the terminal device 15 as the communication target.

In the first embodiment, the POS app of the terminal device 15 can give an instruction with a command of a single language to each peripheral device 30 operating under a unique command specific to the peripheral device 30. In this respect, it can be said that the command language handled by the terminal device 15 is a common command. However, the POS system 11 of the present embodiment employs a command conversion type in which the relay device 12 mutually converts the common command, which is a command of a common language handled by the terminal device 15, and the unique command, which is a command of a plurality of types of unique languages handled independently by each peripheral device 30.

### Functional Configuration of POS System 11

Next, a functional configuration of the POS system 11 will be described with reference to FIG. 2. The control unit 20 of the relay device 12 includes a computer (not illustrated) for executing a program PR stored in the storage unit 21. By the computer executing the program PR, the relay device 12 includes a plurality of functional units configured with software. At least some of the plurality of functional units may be configured by cooperation of software and hardware such as an electronic circuit. As the hardware, the control unit 20 may include, for example, at least one electronic circuit between an application specific integrated circuit (ASIC) and a field programmable gate array (FPGA).

As illustrated in FIG. 2, the relay device 12 includes a plurality of communication ports 40, 41, 42 that allow the terminal device 15 and one or more peripheral devices 30 to be connected. Specifically, the relay device 12 includes a first port 40 and second ports 41, 42. The first port 40 is a port that allows the terminal device 15 to be connected. The first port 40 is a port used for connecting the terminal device 15 among the communication ports. The second ports 41, 42 are ports for connecting the peripheral device 30. For example, if the terminal device 15 is a mobile terminal device, the first port 40 is one among the ports that allow a mobile terminal device to be connected. The first port 40 is, for example, a USB port. The second port 41 is, for example, a USB port. The second port 42 is, for example, a serial port. In the present embodiment, the first port 40 is also referred to as a USB port 40, the second port 41 is also referred to as a USB port 41, and the second port 42 is also referred to as a serial port 42.

The reading device 31, the display device 32, and the printing device 33 are connected to the USB port 41. The automatic change machine 34 and the settlement terminal 35 are connected to the serial port 42. The relay device 12 includes the plurality of USB ports 40, 41. The number of USB ports 40, 41 is, for example, a predetermined number within the range of 2 to 10. In particular, in the embodiment, the number of USB ports 40, 41 is, for example, a predetermined number within the range of 4 to 10. One of the plurality of USB ports 40, 41 that allows the terminal device 15 to be connected is the first port 40. The first port 40 is an upstream port that is the request source in the accounting process of the terminal device 15. The second ports 41, 42 are downstream ports that allow the peripheral device 30 as the request target in the accounting process to be connected. In the accounting process, formed between the first port 40 and the second ports 41, 42 are a transmission path through which a request command is transmitted from the first port 40 to the second ports 41, 42 and a transmission path through which a response command is transmitted from the second ports 41, 42 to the first port 40. These two types of transmission paths may be one signal line or a plurality of signal lines.

The relay device 12 includes a communication unit 43. The communication unit 43 is a port capable of network communication. The communication unit 43 is, for example, a LAN port (for example, an Ethernet (registered trademark) port). The communication unit 43 is communicably connected to the cloud server 14 or the maintenance terminal 16.

As illustrated in FIG. 2, the relay device 12 includes a tethering unit 51, a network communication unit 52, a transmission/reception unit 53, a peripheral device management unit 60, and a maintenance function unit 70. The transmission/reception unit 53 includes a command conversion unit 54, a peripheral device specifying unit 55, a transmission unit 56, and a reception unit 57. The peripheral device management unit 60 includes a monitoring unit 61, an analysis unit 62, a determination unit 63, an information notification unit 64 as an example of a notification unit, and a command issuing unit 65. The maintenance function unit 70 includes a failure detection unit 71 as an example of an abnormality detection unit, an update unit 72, and a log acquisition unit 73. The failure detection unit 71 includes an abnormality notification unit 74.

The tethering unit 51 is a functional unit that enables the terminal device 15 to perform network communication via the relay device 12 even if the terminal device 15 does not have a network communication function. The tethering unit 51 may have, for example, a USB tethering function and a Bluetooth (registered trademark) tethering function. The terminal device 15 can be connected to the cloud server 14 via the relay device 12 by the tethering function of the tethering unit 51.

The network communication unit 52 enables network communication of the relay device 12. The relay device 12 can communicate with the cloud server 14 via the network NW by the function of the network communication unit 52.

The transmission/reception unit 53 performs communication between the terminal device 15 and the one or more peripheral devices 30 connected to the relay device 12. The communication of transmission/reception unit 53 includes the request information to peripheral device 30 and the response information from peripheral device 30.

The transmission/reception unit 53 includes: the transmission unit 56 for transmitting a transmitted command to the peripheral device 30; and the reception unit 57 for receiving a received command from the peripheral device 30. The transmitted command is mainly a request command for transmitting a request from the terminal device 15 to the peripheral device 30. The transmitted command may include a transmitted command transmitted from the cloud server 14 to the peripheral device 30. The received command is mainly a response command for transmitting a response from the peripheral device 30. When a failure occurs in the peripheral device 30, the communication contents of the request command and the response command include some error. Errors of the response command include an error command that responds an error, a response error that no response command is returned, a timeout error, and the like.

The transmission unit 56 transmits the request information to the peripheral device 30. The reception unit 57 receives the response information from the peripheral device 30. The request information includes a command to peripheral device 30. The response information includes a command from peripheral device 30. The request information to the peripheral device 30 passes through the relay device 12. The command transmitted by the relay device 12 to the peripheral device 30 is referred to as the "transmitted command". The response information from the peripheral device 30 passes through the relay device 12. The command received by the relay device 12 from the peripheral device 30 is referred to as the "received command". Here, the transmitted command is an example of request information. The "received command" is an example of response information. The "command" refers to information described in a predetermined command language. In the present specification, the request information and the response information also include data accompanying the command described in the command language.

The command conversion unit 54 performs a command conversion process of converting the transmitted command from the terminal device 15 and the received command from the peripheral device 30 into a command described in a command language that can be interpreted by each. Here, a command described in a command language handled by the terminal device 15 is referred to as a common command. The common command is, for example, an ePOS command.

The command included in the request information is a common command, and the command included in the response information is a unique command specific to the peripheral device 30. The peripheral device 30 of the present embodiment handles unique commands of different command languages for each manufacturer. For example, even if the category is the same, the peripheral device 30 can interpret only a unique command for each manufacturer. In addition, if the categories are different, the manufacturers are often different, and thus only a unique command of each manufacturer can be interpreted.

The relay device 12 includes a command conversion unit 54 capable of mutually converting a common command used by the terminal device 15 and a unique command specifically used by the peripheral device 30. The command conversion unit 54 converts the transmitted command (for example, ePOS command) into a unique command written in a command language specific to the peripheral device. The command conversion unit 54 converts the received command (for example, unique command) to a common command (for example, ePOS command).

The command conversion unit 54 includes a conversion table CT (see FIG. 1) to be referred to when converting a common command (for example, ePOS command) and a unique command that can be interpreted by the peripheral device 30. The command conversion unit 54 refers to the conversion table CT selected based on specific information registered in the peripheral device specifying unit 55, thereby performing command conversion from a common command to a unique command and command conversion from a unique command to a common command. The command conversion unit 54 includes a plurality of types of conversion tables CT as many as the types of unique commands handled by the plurality of peripheral devices 30 connected to the relay device 12.

The command conversion unit 54 converts the common command into the unique command before transmitting the request information to the peripheral device 30. The command conversion unit 54 converts the response information from the peripheral device 30 from a unique command to a common command. The command conversion unit 54 converts the common command into the unique command before transmitting the transmitted command to the peripheral device 30. The command conversion unit 54 converts a received command from the peripheral device 30 from a unique command to a common command.

The peripheral device specifying unit 55 acquires identification information from the peripheral device 30 as the connection target at a specific time such as when the relay device 12 was activated. The peripheral device specifying unit 55 registers the identification information acquired from the peripheral device 30 connected to the relay device 12. The command conversion unit 54 refers to the identification information registered by the peripheral device specifying unit 55, thereby selecting the conversion table CT corresponding to the command language that can be interpreted by the peripheral device 30. The command conversion unit 54 refers to the conversion table CT selected for each peripheral device 30, thereby performing mutual command conversion between the common command and the unique command. When a failure occurs in the POS system 11, the identification information registered in the peripheral device specifying unit 55 is also used to specify and identify the peripheral device 30 that has caused the failure. Further, when a failure occurs in the POS system 11, the identification information registered in the peripheral device specifying unit 55 is also used to specify the language of the unique command issued to the peripheral device 30 to be maintained.

The transmission unit 56 performs a distribution process of distributing a transmitted command including a common command from the terminal device 15 to a port to which the peripheral device 30 as the transmission target is connected. The transmission unit 56 transmits the transmitted command converted into the unique command from one port corresponding to the peripheral device 30 of the transmission target between the second ports 41, 42. The reception unit 57 receives the received command including the unique command as a response from the peripheral device 30 from one port corresponding to the peripheral device 30 of the reception source between the second ports 41, 42.

The transmission unit 56 individually processes transmitted commands transmitted from the USB port 41 by USB communication and transmitted commands transmitted from the serial port 42 by serial communication. The reception unit 57 individually processes received commands received from the USB port 41 by USB communication and received commands received from the serial port 42 by serial communication. The transmission unit 56 converts the common command into the unique command by the command conversion unit 54, and then transmits the converted transmitted command from one port corresponding to the peripheral device 30 of the transmission target between the second ports 41, 42. The received command received by the reception unit 57 from the one port corresponding to the peripheral device 30 as the reception source between the second ports 41, 42 is converted from a unique command to a common command by the command conversion unit 54. A received command including a common command is transmitted from the first port 40 to the terminal device 15.

### Configuration of Peripheral Device Management Unit 60

Next, a configuration of the peripheral device management unit 60 will be described with reference to FIG. 2. The peripheral device management unit 60 manages the peripheral devices 30 via a command transmitted in the relay device 12. As described above, the peripheral device management unit 60 includes the monitoring unit 61, the analysis unit 62, the determination unit 63, the information notification unit 64, and the command issuing unit 65.

The monitoring unit 61 monitors the information group transmitted by the transmission/reception unit 53 to acquire information to be analyzed by the analysis unit 62. That is, the monitoring unit 61 monitors the information group transmitted between the first port 40 and the second ports 41, 42 to acquire the analysis target information to be analyzed among the request information and the response information. The monitoring unit 61 of the present embodiment monitors the information group transmitted between the first port 40 and the second ports 41, 42 to acquire analysis target information including a common command from the information group. The monitoring unit 61 monitors the transmitted command to acquire the common command before the transmitted command is converted into the unique command. The monitoring unit 61 monitors the received command to monitor and acquire the common command after the received command is converted from a unique command to a common command.

The analysis unit 62 analyzes the analysis target information to be analyzed among the request information and the response information. The request information includes the transmitted command and data associated with the transmitted command. The response information includes the received command and data associated with the received command. The analysis unit 62 analyzes the analysis target information acquired by the monitoring unit 61 from the request information and the response information. The analysis unit 62 of the present embodiment analyzes the common command acquired by the monitoring unit 61. The analysis unit 62 may analyze at least the received command among the transmitted command and the received command. The analysis unit 62 may analyze only the transmitted command among the transmitted command and the received command. Therefore, the analysis target information may include not only a command but also data. However, whether to be the analysis target depends on the setting content. In the present embodiment, the command is analyzed to determine the state of the peripheral device 30. A command useful for determining the state of the peripheral device 30 and data associated with the command are set as analysis target information. In the present embodiment, all commands may be the analysis target because the command is analyzed to the extent that simple log information on each peripheral device 30 can be acquired. In addition, data associated with all commands may also be the analysis target. It is also possible to select only a command as the analysis target and not to select data accompanying the command as the analysis target. It is also possible to select a specific command that is particularly effective for the state determination of the peripheral device 30 as the analysis target among all the commands. Alternatively, for only a specific command, it is also possible to set data accompanying the command as the analysis target.

The analysis unit 62 analyzes a command necessary for determining the state of the peripheral device 30. If the received command received as the response to the transmitted command is a command having appropriate response content, the analysis unit 62 can estimate that the state (status) of the peripheral device 30 as the transmission source of the received command is normal. If the received command received as a response to the transmitted command is a command having inappropriate response content, the analysis unit 62 can estimate that the state (status) of the peripheral device 30 as the transmission source of the received command is abnormal. For example, if the received command is an error command, if there is an error number, the error content can be acquired from the error number. In addition, a time over error or a repeatedly retransmitted command can lead to the determination that the state of the peripheral device 30 of the reception source is highly likely not normal. In this way, the analysis information on the abnormality or the failure can be acquired with a certain accuracy or higher by simply analyzing the received command. The analysis unit 62 of the present embodiment analyzes both the transmitted command and the received command to comprehensively acquire the state of the peripheral device 30 and the occurrence of an abnormality or a failure of the peripheral device 30 with high accuracy.

The analysis unit 62 may analyze the state of the peripheral device 30 not only from one request and response but also from a plurality of exchanges of requests and responses within a predetermined period. The analysis unit 62 may adopt an appropriate analysis method. The analysis unit 62 may analyze the state of the peripheral device 30 using, for example, an AI model trained by supervised learning using a failure data set or an AI model subjected to reinforcement learning.

Since the analysis unit 62 takes the common command as the analysis target, and thus can efficiently perform the analysis process. For example, the analysis unit 62 may take a unique command as the analysis target. However, if a unique command is the analysis target, the peripheral device 30 needs to analyze a plurality of types of commands in different languages with reference to the conversion table. In this case, conversion takes time in addition to analysis, which limits the amount of analysis that can be processed within a certain time. This allows only very simple and shallow analysis. On the other hand, the present embodiment, in which the common command is analyzed, does not need to refer to the conversion table, and thus can to secure a long time usable for analysis, and can perform more complicated and deeper analysis within a certain time.

The determination unit 63 determines the state of the peripheral device 30 based on the analysis result of the analysis unit 62. The states of the peripheral device 30 include a normal state and an abnormal state. The abnormal state includes a state in which an abnormality requiring caution is mild (caution state), a state in which an abnormality requiring caution for a maintenance person is moderate (warning state), and a state in which an abnormality of failure occurrence is severe (failure state). As described above, if the state of the peripheral device 30 is abnormal, the determination unit 63 may determine the abnormal state in a plurality of stages according to the difference in degree of importance.

The information notification unit 64 notifies the server 14 of the determination result of the determination unit 63 via the network NW. That is, the information notification unit 64 notifies the server 14 of the state information (status information) on the peripheral device 30, which is the determination result of the determination unit 63. The information notification unit 64 may notify the server 14 of analysis information, which is the analysis result of the analysis unit 62, via the network NW. In this way, the information notification unit 64 also functions as an information transmission unit for transmitting (transferring) the state information and the analysis information. The information notification unit 64 may acquire the state information saved in the storage unit 21 of the relay device 12 by the server 14 through a web application programming interface (API), whereby the server 14 becomes the main subject and the state information is notified (transmitted) from the relay device 12 to the server 14. Similarly, regarding the notification of the analysis result, the information notification unit 64 may acquire the analysis information saved in the storage unit 21 of the relay device 12 by the server 14 through the web API, whereby the server 14 becomes the main subject and the analysis information is notified (transmitted) from the relay device 12 to the server 14. The information notification unit 64 may be configured to periodically or irregularly notify the server 14 that the state information or the analysis information has been accumulated in the storage unit 21. Upon receiving the notification, the server 14 may acquire the state information or the analysis information from the storage unit 21 through the web API.

The command issuing unit 65 issues commands that can be interpreted by the printing device 33. The command issuing unit 65 issues a command to the printing device 33 based on a request from outside the relay device 12. For example, when the relay device 12 receives a request (order) from the server 14 or the maintenance terminal 16, the command issuing unit 65 issues a command corresponding to the request to the printing device 33. The command issuing unit 65 may cause the printing device 33 to issue a command based on the determination result of the control unit 20. For example, the command issuing unit 65 issues a maintenance command based on an instruction of the maintenance function unit 70. When a maintenance function unit 70 described below receives a maintenance request (maintenance order) from the server 14 or the maintenance terminal 16, the command issuing unit 65 issues a maintenance command according to an instruction from the maintenance function unit 70. The maintenance command is a command requesting a predetermined maintenance process for the printing device 33.

An example of the maintenance command issued by the command issuing unit 65 is an update command for updating firmware of the printing device 33. An example of the maintenance command is a log acquisition command for causing the printing device 33 to acquire log information. The log information on the printing device 33 is a detailed log recorded in the printing device 33 itself. The detailed log is information describing the operation, state, and the like of the printing device 33 in time series, which is in detail as compared with the command analysis information obtained from the analysis result of the analysis unit 62 and the state information (status information) of the peripheral device 30 as the determination result of the determination unit 63.

### Configuration of Maintenance Function Unit 70

Next, a configuration of the maintenance function unit 70 will be described with reference to FIG. 2.

The maintenance function unit 70 performs a maintenance process on the peripheral device 30. The maintenance function unit 70 has a failure detection function of detecting a failure of the peripheral device 30 and a remote maintenance operation function of causing the printing device 33 to perform the maintenance process by remote control. The maintenance function unit 70 includes a failure detection unit 71 and an abnormality notification unit 74 as functional units for implementing the failure detection function. As illustrated in FIG. 2, the abnormality notification unit 74 may be included in the failure detection unit 71, or the abnormality notification unit 74 may be included separately from the failure detection unit 71.

The failure detection unit 71 detects a failure of the peripheral device 30 based on the analysis result of the analysis unit 62 or the determination result of the determination unit 63. That is, the failure detection unit 71 detects a failure of the peripheral device 30 based on the analysis information as the analysis result of the analysis unit 62 or the state information as the determination result of the determination unit 63.

When the failure detection unit 71 detects a failure, the abnormality notification unit 74 notifies the cloud server 14 or the maintenance terminal 16 of the abnormality of the peripheral device 30. If the determination unit 63 acquires a determination result indicating that a failure has occurred in the peripheral device 30, the abnormality notification unit 74 may notify the cloud server 14 or the maintenance terminal 16 of information indicating that a failure has occurred.

Upon receiving a maintenance request, the remote maintenance operation function of the maintenance function unit 70 causes the command issuing unit 65 to issue a maintenance command to cause the printing device 33 to perform the maintenance process. The maintenance function unit 70 includes an update unit 72 and a log acquisition unit 73 as functional units for implementing the remote maintenance operation function.

The update unit 72 causes the printing device 33 to update the firmware. Upon receiving the update request, the update unit 72 issues an update command to the printing device 33 to cause the printing device 33 to update the firmware. Upon receiving an update request for updating the firmware of the printing device 33 as the maintenance request from the cloud server 14, the update unit 72 causes the command issuing unit 65 to issue an update command. Upon receiving an update order for updating the firmware of the printing device 33 from the maintenance terminal 16, the cloud server 14 issues an update request to the relay device 12.

The log acquisition unit 73 causes the command issuing unit 65 to issue a log acquisition command for causing the printing device 33 to acquire log information. Upon receiving a log acquisition request for acquiring log information on the printing device 33 as the maintenance request from the cloud server 14, the log acquisition unit 73 causes the command issuing unit 65 to issue a log acquisition command. Upon receiving a log acquisition order for acquiring a log of the printing device 33 from the maintenance terminal 16, the cloud server 14 issues a log acquisition request to the relay device 12.

The cloud server 14 includes a database 81 and a simple log generation unit 82. The database 81 saves at least one of the analysis information, which is the result of the lower tilting mechanism 60 of the analysis unit 62, and the state information, which is the determination result of the determination unit 63. The simple log generation unit 82 generates a simple log based on the database 81. The simple log generation unit 82 generates a simple log of the designated peripheral device 30 in response to the simple log generation request.

### Maintenance Method

The present embodiment includes maintenance methods for the POS system 11 as described below. There are the following three maintenance methods for the POS system 11. In each of the three maintenance methods, the POS system 11 includes a terminal device 15 capable of executing an accounting process, one or more peripheral devices 30, and a relay device 12 for relaying the terminal device 15 and the peripheral devices 30.

### First Maintenance Method

The relay device 12 includes a transmission unit 56 for transmitting request information to the peripheral devices 30 and a reception unit 57 for receiving response information from the peripheral devices 30. The maintenance method for the POS system 11 for maintaining the peripheral devices 30 includes the following (A1) and (A2).

(A1) Analyze the analysis target information to be analyzed among the request information and the response information.

(A2) Acquire maintenance information available for maintaining the peripheral device 30 based on the analysis result of the analysis target information, and output the maintenance information to an output unit of a device capable of communicating with the relay device 12.

### Second Maintenance Method

The relay device 12 includes a communication unit 43 communicably connected to the server 14 or the maintenance terminal 16, a transmission unit 56 for transmitting request information to the peripheral devices 30, and a reception unit 57 for receiving response information from the peripheral devices 30. The maintenance method for the POS system 11 includes the following (B1) to (B3).

(B1) Analyze the analysis target information to be analyzed among the request information and the response information.

(B2) Detect an abnormality of the peripheral device 30 based on the analysis result of the analysis target information.

(B3) Upon detecting an abnormality, notify the server 14 or the maintenance terminal 16 of information indicating that the peripheral device 30 is abnormal.

### Third Maintenance Method

The relay device 12 includes a communication unit 43 communicably connected to the server 14 or the maintenance terminal 16, a transmission unit 56 for transmitting request information to the peripheral devices 30, and a reception unit 57 for receiving response information from the peripheral devices 30. The maintenance method for the POS system 11 includes the following (C1) to (C4).

(C1) Upon detecting an abnormality of the printing device 33 based on the analysis result obtained by analyzing the analysis target information to be analyzed among the request information and the response information, notify the server 14 or the maintenance terminal 16 of information indicating the abnormality.

(C2) Upon receiving a maintenance request for the printing device 33 from the server 14 or the maintenance terminal 16, issue a maintenance command corresponding to the maintenance request and transmit the maintenance command to the printing device 33.

(C3) The printing device 33 executes a maintenance process instructed by the maintenance command.

(C4) Upon receiving outcome information on the maintenance process or completion information on the maintenance process from the printing device 33, send the outcome information or the completion information to the server 14 or the maintenance terminal 16.

### Program PR

The above-described three maintenance methods can be provided as a program PR executed by a computer included in the control unit 20 of the relay device 12. The program PR is provided in a form stored in a storage medium. The program PR is provided by downloading from a server such as the cloud server 14.

### First Program

The relay device 12 includes a transmission unit 56 for transmitting request information to the peripheral device 30 and a reception unit 57 for receiving response information from the peripheral device 30. The first program PR is a program for causing the computer of the control unit 20 to execute the following (A1) and (A2). (A1) Analyze the analysis target information to be analyzed among the request information and the response information.

(A2) Acquire maintenance information available for maintaining the peripheral device 30 based on the analysis result of the analysis target information, and output the maintenance information to an output unit of a device capable of communicating with the relay device 12.

### Second Program

The relay device 12 includes a communication unit 43 communicably connected to the server 14 or the maintenance terminal 16, a transmission unit 56 for transmitting request information to the peripheral devices 30, and a reception unit 57 for receiving response information from the peripheral devices 30. The second program PR is a program for causing the computer of the control unit 20 to execute the following (B1) to (B3).

(B1) Analyze the analysis target information to be analyzed among the request information and the response information.

(B2) Detect an abnormality of the peripheral device 30 based on the analysis result of the analysis target information.

(B3) Upon detecting an abnormality, notify the server 14 or the maintenance terminal 16 of information indicating that the peripheral device 30 is abnormal.

### Third Program

The relay device 12 includes a communication unit 43 communicably connected to the server 14 or the maintenance terminal 16, a transmission unit 56 for transmitting request information to the peripheral devices 30, and a reception unit 57 for receiving response information from the peripheral devices 30. The third program PR is a program for causing the computer of the control unit 20 to execute the following (C1) to (C4).

(C1) Upon detecting an abnormality of the printing device 33 based on the analysis result obtained by analyzing the analysis target information to be analyzed among the request information and the response information, notify the server 14 or the maintenance terminal 16 of information indicating the abnormality.

(C2) Upon receiving a maintenance request for the printing device 33 from the server 14 or the maintenance terminal 16, issue a maintenance command corresponding to the maintenance request and transmit the maintenance command to the printing device 33.

(C3) The printing device 33 executes a maintenance process instructed by the maintenance command.

(C4) Upon receiving outcome information on the maintenance process or completion information on the maintenance process from the printing device 33, send the outcome information or the completion information to the server 14 or the maintenance terminal 16.

### Operation of First Embodiment

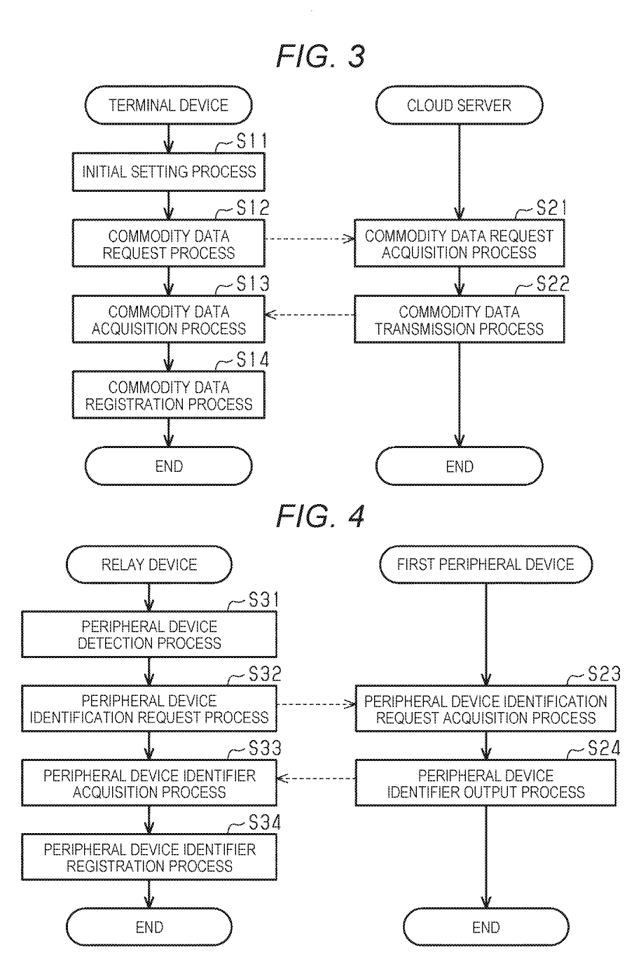

The operation of the relay device 12 configured as described above, the POS system 11 including the relay device 12, and the cloud server 14, which is an example of a server, are described next with reference to FIGS. 3 to 14. Hereinafter, an activation control process, a peripheral device identification process, an accounting control process, a state determination / failure detection process, and a maintenance process will be described in order. The maintenance process includes a simple log generation process, a detailed log acquisition process, and a firmware update process.

### Activation Control Process

The activation control process will be described with reference to FIG. 3. The activation control process is a process executed by the terminal device 15 when the application of the terminal device 15 is activated.

As illustrated in FIG. 3, in step S11, the terminal device 15 executes an initial setting process. In this process, the terminal device 15 performs initial setting for using the application.

In step S12, the terminal device 15 executes a commodity data request process. In this process, the terminal device 15 transmits a commodity data request to the cloud server 14. The commodity data request is a request for acquiring the latest commodity data. The commodity data may include a commodity identifier, a commodity name, and a price.

In step S21, the cloud server 14 executes a commodity data request acquisition process. In this process, the cloud server 14 receives the commodity data request from the terminal device 15.

In step S22, the cloud server 14 executes a commodity data transmission process. In this process, the cloud server 14 transmits the latest registered commodity data to the terminal device 15 that has transmitted the commodity data request.

In step S13, the terminal device 15 executes a commodity data acquisition process. In this process, the terminal device 15 receives the commodity data transmitted from the cloud server 14. Accordingly, the terminal device 15 acquires the commodity data.

In step S14, the terminal device 15 executes a commodity data registration process. In this process, the terminal device 15 registers the acquired commodity data in the memory. Accordingly, the terminal device 15 can perform control based on the latest commodity data.

### Peripheral Device Identification Process

The peripheral device identification process will be described with reference to FIG. 4. The peripheral device identification process is a process executed by the control unit 20 when the peripheral device 30 is electrically connected to the relay device 12.

As illustrated in FIG. 4, in step S31, the control unit 20 executes a peripheral device detection process. In this process, the control unit 20 detects that the peripheral device 30 is connected to the relay device 12. The control unit 20 recognizes the connection port at which the peripheral device 30 is connected to the relay device 12.

In step S32, the control unit 20 executes a peripheral device identification request process. In this process, the control unit 20 outputs a peripheral device identification request to the connected peripheral device 30. The peripheral device identification request is a request for acquiring the peripheral device identifier.

In step S23, the peripheral device 30 executes a peripheral device identification request acquisition process. In this process, the peripheral device 30 receives the peripheral device identification request transmitted from the relay device 12. Thereby, the peripheral device 30 acquires the peripheral device identification request.

In step S24, the peripheral device 30 executes a peripheral device identifier output process. In this process, the peripheral device 30 outputs the peripheral device identifier to the relay device 12. The peripheral device identifier is registered in the memory of the peripheral device 30.

In step S33, the control unit 20 executes a peripheral device identifier acquisition process. In this process, the control unit 20 receives the peripheral device identifier from the connected peripheral device 30. Accordingly, the control unit 20 acquires the peripheral device identifier of the connected peripheral device 30.

In step S34, the control unit 20 executes a peripheral device identifier registration process. In this process, the control unit 20 registers the acquired peripheral device identifier in the storage unit 21. In particular, the control unit 20 registers the connection port at which the peripheral device 30 is connected to the relay device 12 and the peripheral device identifier in the storage unit 21 in association with each other. Specifically, the peripheral device specifying unit 55 (see FIG. 2) registers the connection port and the peripheral device identifier in association with each other. Accordingly, the control unit 20 can identify the peripheral device 30 connected to the relay device 12. The peripheral device identifier includes, for example, a vendor ID and a device ID of the peripheral device 30.

### Accounting Control Process

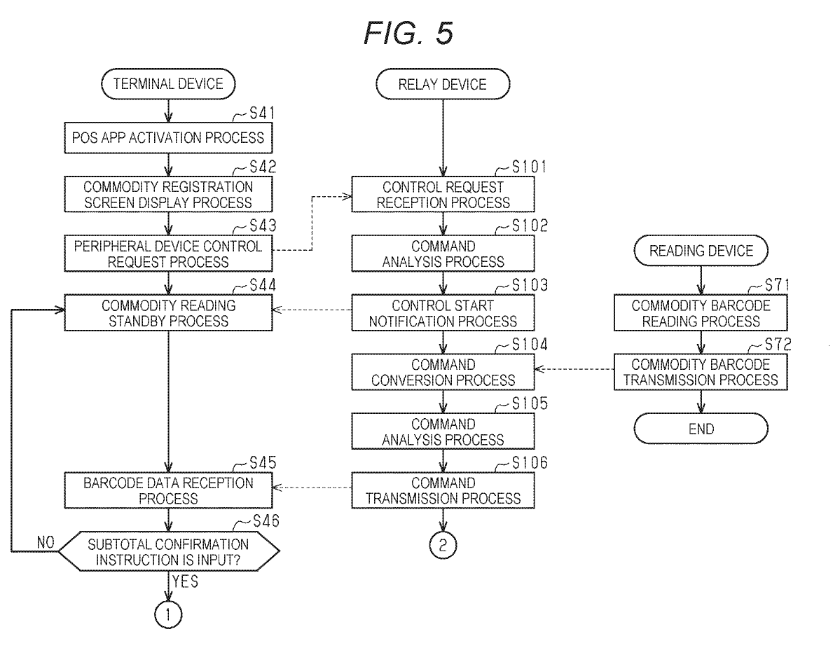

In the activated state of the terminal device 15, the user activates a POS application (hereinafter, also simply referred to as a "POS app") by operating the operation unit. The POS app is accounting processing software. The accounting process is performed in the order of a commodity reading process, a total amount display process, a settlement process, and a receipt issuing process. The settlement process includes cash settlement and electronic settlement. In the present embodiment the relay device 12 executes a state determination process for determining the state of each peripheral device 30 for the purpose of maintaining the POS system 11 after the accounting process ends. The state determination process is executed by analyzing the analysis target information extracted as the analysis target among the request information and the response information exchanged between the terminal device 15 and each peripheral device 30 during the accounting process. Hereinafter, with reference to FIGS. 5 to 11, each process constituting the accounting process will be described in order including the analysis process of the analysis target information extracted from the request information and the response information. In the present embodiment, the request information and the response information are commands exchanged between the terminal device 15 and each peripheral device 30 in the accounting process.

### Commodity Reading Process

First, a commodity reading process performed among the terminal device 15, the relay device 12, and the reading device 31 will be described.

In step S41, the terminal device 15 activates the POS app.

In step S42, the terminal device 15 performs a commodity registration screen display process. The commodity registration screen includes a subtotal button.

In step S43, the terminal device 15 performs a peripheral device control request process. The peripheral device control request is a process of requesting the relay device 12 to control the peripheral device 30. The peripheral device control request is made by sending a peripheral device control request command to the relay device 12.

In the relay device 12, the control unit 20 executes a control request reception process in step S101. The control unit 20 receives the peripheral device control request command in the control request reception process.

In the next step S102, the control unit 20 executes a command analysis process. The control unit 20 analyzes the peripheral device control request command. The command analysis process is a process of collecting information useful for managing the state of the peripheral device 30 from the viewpoint of maintenance through command analysis in addition to the accounting process necessary for the accounting control process. The control unit 20 collects maintenance information for determining whether the peripheral device 30 is in a normal state or an abnormal state by the command analysis process. The control unit 20 saves the analysis information obtained as the command analysis result in the storage unit 21.

In the next step S103, the control unit 20 executes a control start notification process. By the control start notification process, the terminal device 15 occupies each peripheral device 30 in the accounting control without being interrupted by another terminal device.

In step S44, the terminal device 15 performs a commodity reading standby process. When the commodity is read by the reading device 31, the terminal device 15 waits until the barcode data is transmitted as commodity reading data. The user causes the reading device 31 to read the barcode of the commodity.

In step S71, the reading device 31 executes a commodity barcode reading process. The commodity barcode reading process is a process of reading the barcode of the commodity. The reading device 31 acquires the barcode data on the commodity by the barcode reading process.

In the next step S72, the reading device 31 executes a commodity barcode transmission process. The commodity barcode transmission process is a process of transmitting the barcode of the commodity to the relay device 12. The response information transmitted in the commodity barcode transmission process includes a command and barcode data.

In step S104, the relay device 12 executes a command conversion process. The control unit 20 selects the conversion table CT used when converting the unique command used by the reading device 31 into a common command based on the identification information on the reading device 31 registered in the peripheral device specifying unit 55. The control unit 20 executes a command conversion process of converting the unique command from the reading device 31 into a common command with reference to the selected conversion table CT.

In step S105, the control unit 20 executes a command analysis process. The control unit 20 saves the analysis information obtained as the command analysis result in the storage unit 21.

In step S106, the control unit 20 executes a command transmission process. The command transmission process is a process of transmitting the common command and the barcode data to the terminal device 15. This command transmission process is also a barcode data transmission process. The command transmission process corresponds to a process of converting the received command from the reading device 31 from a unique command to a common command and then transmitting the command to the terminal device 15.

In step S45, the terminal device 15 performs a barcode data reception process. The barcode data reception process is a process of receiving barcode data on the commodity. The terminal device 15 receives the common command and the barcode data.

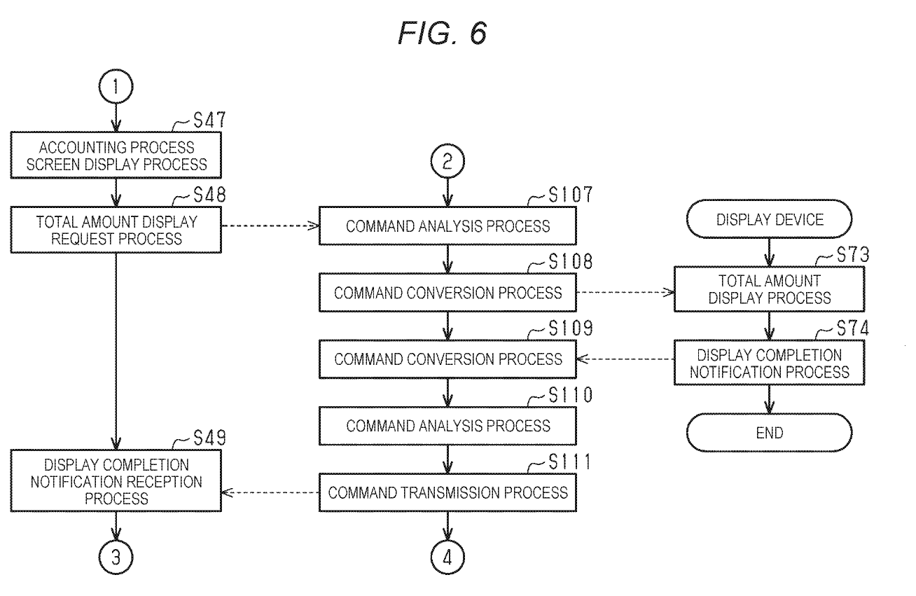

In step S46, the terminal device 15 determines whether a subtotal confirmation instruction is input. The user selects the subtotal button displayed on the terminal device 15 when confirming the subtotal. When the subtotal button on the display screen is selected, the terminal device 15 determines that a subtotal confirmation instruction is input. If a subtotal confirmation instruction is input, the terminal device 15 proceeds to the process of step S47 in FIG. 6. On the other hand, if no subtotal confirmation instruction is input, the terminal device 15 returns to the process of step S44 and again performs the commodity reading standby process of waiting for the reception of the barcode data on the next commodity. In this way, in step S46, the process of acquiring the barcode data on the commodity by the terminal device 15, the relay device 12, and the reading device 31 is repeatedly executed until a subtotal confirmation instruction is input.

### Display Process

Next, the continuation of the accounting process after a subtotal confirmation instruction is input will be described with reference to FIG. 6.

In step S47, the terminal device 15 executes an accounting process screen display process. In this process, the terminal device 15 causes the display device 32 to display an accounting process screen and a denomination button.

In step S48, the terminal device 15 executes a total amount display request process. In this process, the terminal device 15 requests the display device 32 to display the total amount. The request information includes a common command and total amount data. The common command is a display request command.

In step S107, the control unit 20 executes a command analysis process. In this process, the control unit 20 analyzes the display request command including the common command and the total amount data. The control unit 20 analyzes the display request command including the common command according to a predetermined analysis rule set in advance from the viewpoint of acquiring analysis information for determining the state of the peripheral device 30 (display device 32) as the command transmission target. The control unit 20 saves the analysis result in the storage unit 21.

In step S108, the control unit 20 executes a command conversion process. The control unit 20 refers to the conversion table CT selected based on the identification information on the display device 32 registered in the peripheral device specifying unit 55, and converts the display request command from a common command to a unique command.

In step S73, the display device 32 executes a total amount display process. In this process, the display device 32 displays the total amount based on the total amount data according to the instruction of the display request command including the received unique command.

In step S74, the display device 32 executes a display completion notification process. In this process, the display device 32 transmits response information including a value and a display completion command including a unique command to the relay device 12.

In step S109, the control unit 20 executes a command conversion process. In this process, the control unit 20 converts the display completion command from a unique command to a common command.

In step S110, the control unit 20 executes a command analysis process. In this process, the control unit 20 analyzes the response information including the value and the display completion command including the common command. The control unit 20 saves the analysis result in the storage unit 21.

In step S111, the control unit 20 executes a command transmission process. In this process, the control unit 20 transmits response information including a value and a display completion command including a common command to the terminal device 15.

In step S49, the terminal device 15 executes a display completion notification reception process. In this process, the terminal device 15 receives the response information including the value and the display completion command including the common command.

### Cash Settlement Process

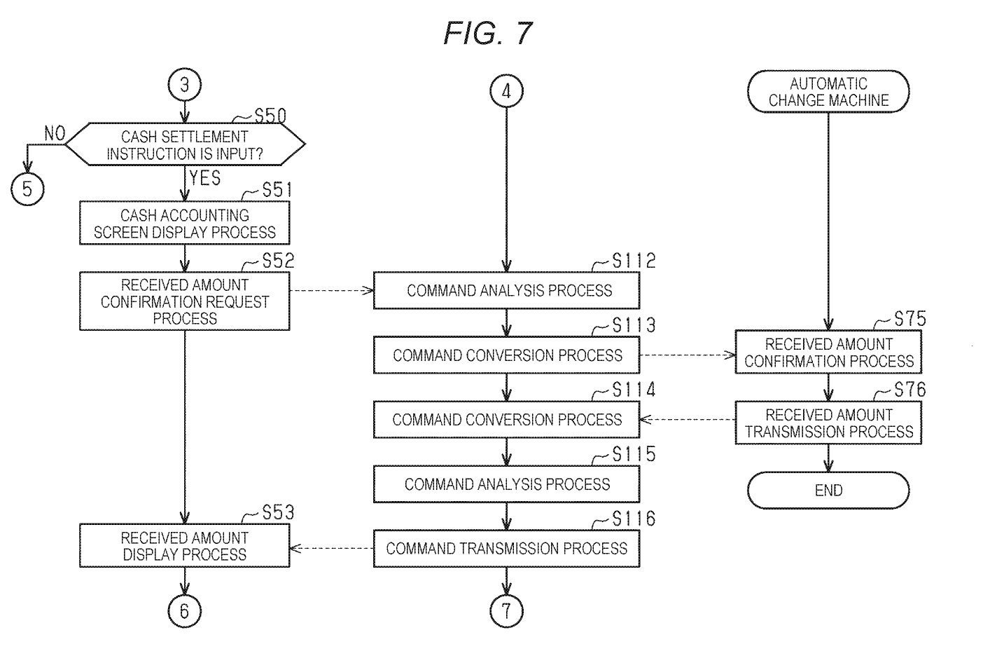

Next, with reference to FIG. 7, the subsequent processes of the accounting process after the display of the total amount on the display device 32 is completed will be described.

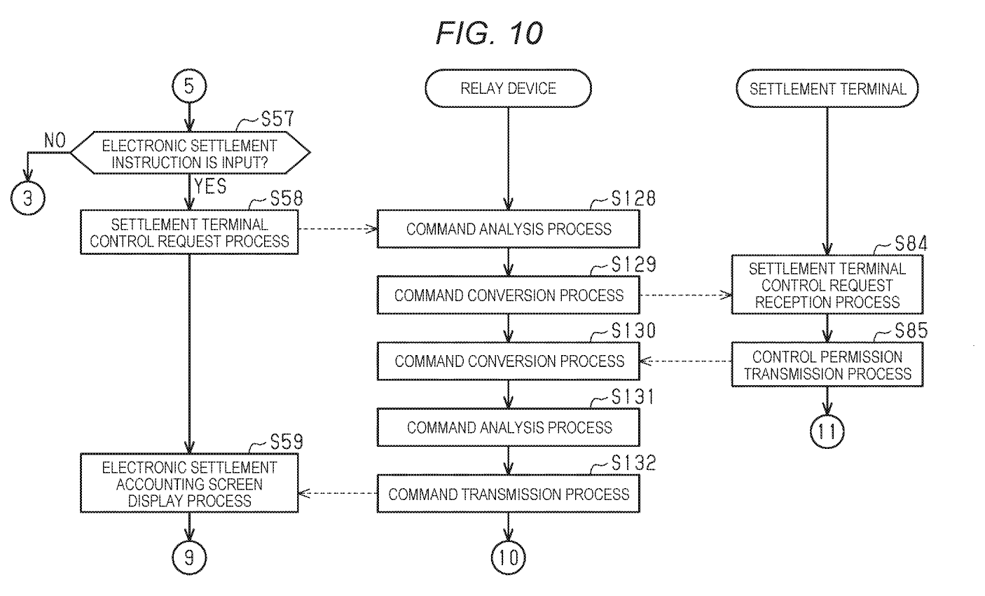

In step S50, the terminal device 15 determines whether a cash settlement instruction has been input. After confirming the total amount displayed on the display device 32, the user selects the denomination button to be next used for settlement. The user can select cash settlement or electronic settlement with the denomination button displayed on the screen of the terminal device 15. The terminal device 15 determines whether a cash settlement instruction has been input. If a cash settlement instruction is input, the process proceeds to step S51, and if no cash settlement instruction is input, the process proceeds to step S57 (FIG. 10).

In step S51, the terminal device 15 executes a cash accounting screen display process. In this process, the terminal device 15 displays a cash accounting screen.

In step S52, the terminal device 15 executes a received amount confirmation request process. In this process, the terminal device 15 requests the automatic change machine 34 to confirm the received amount. The received amount confirmation request information includes, for example, a value and a received amount confirmation command including a common command.

In step S112, the control unit 20 executes a command analysis process. In this process, the control unit 20 analyzes the request information including the received amount confirmation command including the common command. The control unit 20 saves the analysis result in the storage unit 21.

In step S113, the control unit 20 executes a command conversion process. In this process, the control unit 20 converts the received amount confirmation command from a common command to a unique command. Request information including the received amount confirmation command including the unique command is transmitted to the automatic change machine 34.

In step S75, the automatic change machine 34 executes a received amount confirmation process. In this process, the automatic change machine 34 executes a reception confirmation process in accordance with the instruction of the received amount confirmation command, and also executes a change discharge process if there is change.

In step S76, the automatic change machine 34 executes a received amount transmission process. In this process, the automatic change machine 34 transmits response information including received amount data and a received amount transmission command including a unique command to the relay device 12.

In step S114, the control unit 20 executes a command conversion process. In this process, the control unit 20 converts the received amount transmission command from a unique command to a common command.

In step S115, the control unit 20 executes a command analysis process. In this process, the control unit 20 analyzes the response information including the received amount data and the received amount transmission command including the common command. The control unit 20 saves the analysis result in the storage unit 21.

In step S116, the control unit 20 executes a command transmission process. In this process, the control unit 20 transmits response information including received amount data and a received amount transmission command including a common command to the terminal device 15.

In step S53, the terminal device 15 executes a received amount display process. In this process, the terminal device 15 displays the received amount based on the received amount data included in the response information.

### Receipt Issuing Process

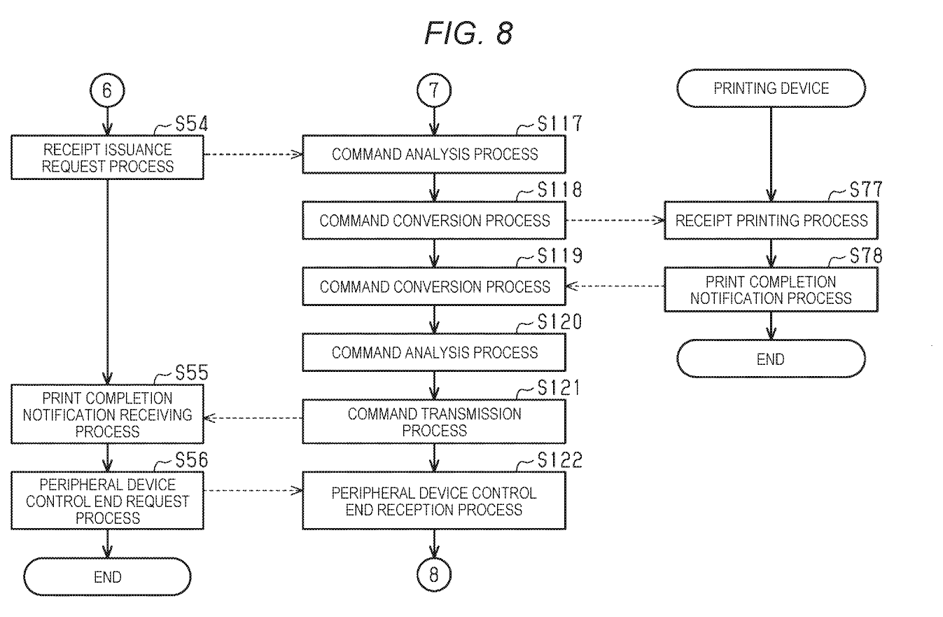

Next, a receipt issuing process after cash settlement is completed will be described with reference to FIG. 8.

In step S54, the terminal device 15 executes a receipt issuance request process. In this process, the terminal device 15 transmits request information including print data and a receipt issuing command including a common command to the relay device 12.

In step S117, the control unit 20 executes a command analysis process. In this process, the control unit 20 analyzes the request information including the print data and the receipt issuing command including the common command. The control unit 20 saves the analysis result in the storage unit 21.

In step S118, the control unit 20 executes a command conversion process. In this process, the control unit 20 refers to the conversion table CT selected based on the identification information on the printing device 33 registered in the peripheral device specifying unit 55, and converts the receipt issuing command from a common command to a unique command. The control unit 20 transmits request information including receipt print data and a receipt issuing command including a unique command to the printing device 33.

In step S77, the printing device 33 executes a receipt printing process. In this process, the printing device 33 prints a receipt based on the receipt print data according to the instruction of the receipt issuing command including the received unique command.

In step S78, the printing device 33 executes a print completion notification process. In this process, the printing device transmits response information including a value and a printing completion command including a unique command to the relay device 12.

In step S119, the control unit 20 executes a command conversion process. In this process, the control unit 20 converts the print completion command from a unique command to a common command.

In step S120, the control unit 20 executes a command analysis process. In this process, the control unit 20 analyzes the response information including the value and the print completion command including the common command. The control unit 20 saves the analysis result in the storage unit 21.

In step S121, the control unit 20 executes a command transmission process. In this process, the control unit 20 transmits response information including a value and a print completion command including a common command to the terminal device 15.

In step S55, the terminal device 15 executes a print completion notification reception process. In this process, the terminal device 15 receives the response information including the value and the print completion command including the common command.

In step S56, the terminal device 15 executes a peripheral device control end request process. In this process, the terminal device 15 transmits request information including a value and a peripheral device control end command including a common command to the relay device 12.

In step S122, the control unit 20 executes a peripheral device control end reception process. In this process, upon receiving the peripheral device control end command including the common command, the control unit 20 determines a failure of the peripheral device 30.

### State Determination / Failure Detection Process

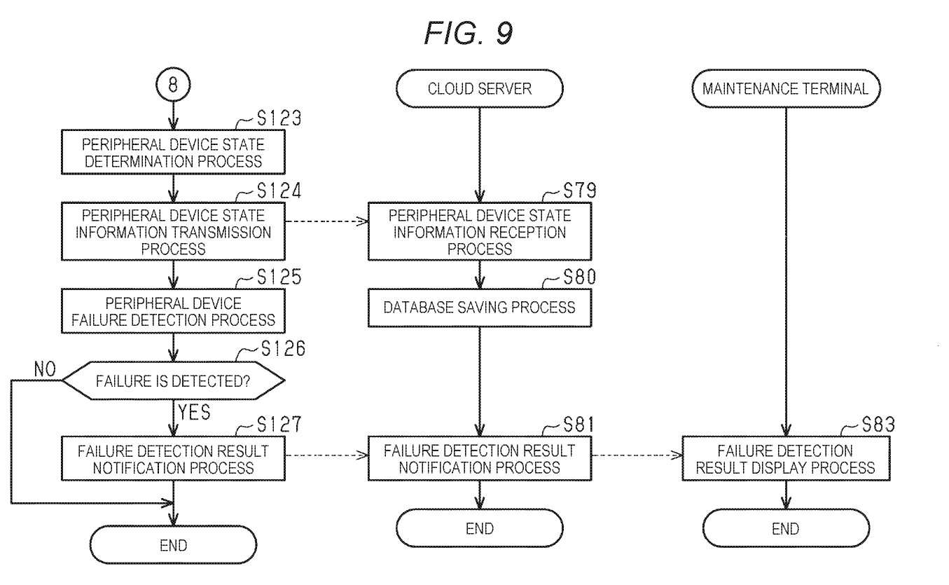

Next, a state determination / failure detection process after cash settlement is completed will be described with reference to FIG. 9.

In step S123, the control unit 20 executes a peripheral device state determination process. In this process, the control unit 20 determines the state (status) of each peripheral device 30 based on the analysis result saved in the storage unit 21. Specifically, the determination unit 63 determines the state of each peripheral device 30. The state of each peripheral device 30 is determined by dividing the state of abnormality into a plurality of stages according to the degree of importance, such as normal, mild abnormality, moderate abnormality, and severe abnormality. For example, the determination unit 63 may determine states divided into a plurality of stages for each type of abnormality. For example, the status may be two types including normal/abnormal, may be 2 to 5 types by dividing the state of the abnormality into a plurality of stages, or may be divided into for 2 to 10 types of abnormality and then into 6 to 50 types by dividing each type into a plurality of stages. The control unit 20 saves the determination result in the storage unit 21.

In step S124, the control unit 20 executes a peripheral device state information transmission process. In this process, the control unit 20 transmits state information (status information) for each peripheral device 30 to the cloud server 14.

In step S79, the cloud server 14 executes a peripheral device state information reception process. In this process, the cloud server 14 receives the state information for each peripheral device 30 from the relay device 12.

In step S80, the cloud server 14 executes a database saving process. In this process, the cloud server 14 saves the state information for each peripheral device 30 in the database 81. The database 81 may be divided into, for example, the type of the peripheral device 30, normality/abnormality, the type of abnormality, the stage of abnormality, the time, the accounting identification number, and the like.

In step S125, the control unit 20 executes a peripheral device failure detection process. In this process, the control unit 20 executes a failure detection process for detecting a failure for each peripheral device 30 based on the database 81. Specifically, the failure detection unit 71 executes the failure detection process. The failure detection unit 71 may perform the failure detection process based on data for one accounting process, or may perform the failure detection process including failure determination elements for comprehensively detecting a failure based on the database for a plurality of accounting processes including the past history. For example, the failure detection unit 71 detects, as a failure, a state of an abnormality exceeding a reference as a failure based on the reference.

In step S126, the control unit 20 determines whether a failure has been detected. In this process, the control unit 20 determines whether a failure has been detected from the result of the failure detection process. Specifically, the failure detection unit 71 also determines whether a failure has been detected.

In step S127, the control unit 20 notifies the failure detection result. In this process, the control unit 20 notifies the cloud server 14 of the failure detection result. Specifically, the abnormality notification unit 74 specifies the peripheral device 30 in which the failure has occurred and notifies the cloud server 14 that the failure has been detected.

In step S81, the cloud server 14 executes a failure detection result notification process. In this process, upon receiving the notification of the failure detection result from the relay device 12, the cloud server 14 specifies the peripheral device 30 in which the failure has occurred and notifies the maintenance terminal 16 of the failure detection result.

In step S83, the maintenance terminal 16 executes a failure detection result display process. In this process, the maintenance terminal 16 specifies the peripheral device 30 in which the failure has occurred and displays information indicating that the failure has been detected.

### Electronic Settlement Process

Next, an electronic settlement process will be described with reference to FIG. 10.

In step S57, the terminal device 15 determines whether an electronic settlement instruction has been input. The terminal device 15 determines whether an electronic settlement instruction is input by selecting electronic settlement by the denomination button.

In step S58, the terminal device 15 executes a settlement terminal control request process. In this process, the terminal device 15 requests the settlement terminal 35 to perform exclusive control. The request information passes through the relay device 12.

In step S128, the control unit 20 executes a command analysis process. In this process, the control unit 20 analyzes the request information including the control request command including the common command. The control unit 20 saves the analysis result in the storage unit 21.

In step S129, the relay device 12 executes a command conversion process. In this process, the control unit 20 converts the control request command from a common command to a unique command with reference to the conversion table CT selected based on the identification information on the settlement terminal 35.

In step S84, the settlement terminal 35 executes a settlement terminal control request reception process. In this process, the settlement terminal 35 receives request information including a control request command including a unique command.

In step S85, the settlement terminal 35 executes a control permission transmission process. In this process, the settlement terminal 35 permits exclusive control according to the instruction of the control request command. That is, the settlement terminal 35 permits the terminal device 15 to occupy use the control.

In step S130, the control unit 20 executes a command conversion process. In this process, the control unit 20 converts a control permission command received from the settlement terminal 35 from a unique command to a common command.

In step S131, the control unit 20 executes a command analysis process. In this process, the control unit 20 analyzes the response information including the control permission command including the common command. The control unit 20 saves the analysis result in the storage unit 21.

In step S132, the control unit 20 executes a command transmission process.

In step S59, the terminal device 15 executes an electronic settlement accounting screen display process. In this process, the terminal device 15 displays an electronic settlement accounting screen.

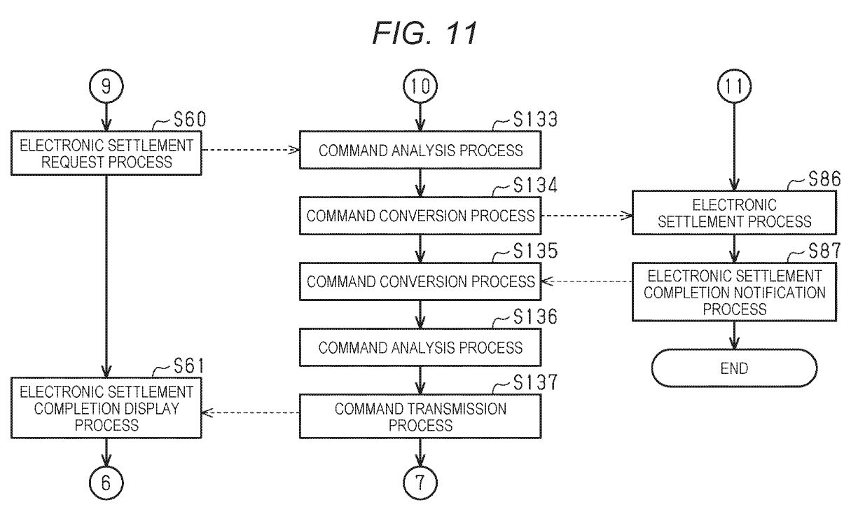

Next, in step S60 illustrated in FIG. 11, the terminal device 15 executes an electronic settlement request process. In this process, the terminal device 15 transmits request information including an electronic settlement command including a common command to the settlement terminal 35. The request information passes through the relay device 12.

In step S133, the control unit 20 executes a command analysis process. The control unit 20 analyzes the request information including the electronic settlement command including the common command. The control unit 20 saves the analysis result in the storage unit 21.

In step S134, the control unit 20 executes a command conversion process. In this process, the control unit 20 converts the electronic settlement command from a common command to a unique command.

In step S86, the settlement terminal 35 executes an electronic settlement process. In this process, the settlement terminal 35 executes the electronic settlement process according to the instruction of the electronic settlement command.

In step S87, the settlement terminal 35 executes an electronic settlement completion notification process. In this process, the settlement terminal 35 transmits response information including a value and an electronic settlement completion command including a common command.

In step S135, the control unit 20 executes a command conversion process. In this process, the control unit 20 converts the electronic settlement completion command from a unique command to a common command.

In step S136, the control unit 20 executes a command analysis process. In this process, the control unit 20 analyzes the response information including the electronic settlement completion command including the common command. The control unit 20 saves the analysis result in the storage unit 21.

In step S137, the control unit 20 executes a command transmission process. In this process, the control unit 20 transmits response information including an electronic settlement completion command including a common command to the terminal device 15.

In step S61, the terminal device 15 executes an electronic settlement completion display process. In this process, the terminal device 15 displays information indicating the completion of the electronic settlement according to the instruction of an electronic settlement completion display command.

### Maintenance Process

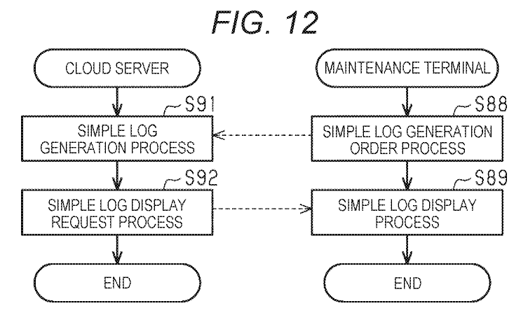

Next, a maintenance process that can be performed by accessing the cloud server 14 from the maintenance terminal 16 will be described with reference to FIGS. 12 to 14. The maintenance process mainly includes a simple log generation process, a detailed log acquisition process, and a firmware update process. Hereinafter, these maintenance processes will be described in order.

### Simple Log Generation Process

First, the simple log generation process will be described with reference to FIG. 12. For example, in the following case, the maintenance person operates the maintenance terminal 16 to order the cloud server 14 to generate a simple log. Examples thereof include when a call center receives an order from a store to recover from a failure of the POS system 11, and when a field engineer checks the cause of a failure of the POS system 11 at a repair center or the like. Other examples include when, as a result of detecting a failure of the failure detection process from the cloud server 14, the maintenance terminal 16 is notified of the abnormality and thus a maintenance person checks the cause of the failure. The maintenance person operates the input unit of the maintenance terminal 16 to order generation of a simple log.

In step S88, the maintenance terminal 16 executes a simple log generation order process. When the maintenance person operates the input unit of the maintenance terminal 16 to order generation of a simple log, the maintenance terminal 16 executes a simple log generation order process of ordering the cloud server 14 to generate a simple log. At this time, the maintenance person can select a peripheral device 30 as the target of the simple log generation. When the peripheral device 30 that is the cause of the failure is narrowed down, only one peripheral device 30 as the target is selected and ordered to generate a simple log. On the other hand, when the peripheral device 30 as the cause of the failure is not specified, all the peripheral devices 30 are selected and ordered to generate a simple log.

In step S91, the cloud server 14 executes a simple log generation process. The cloud server 14 generates a simple log of the designated peripheral device 30. The database 81 of the cloud server 14 stores state information and analysis results in chronological order for each peripheral device 30. The cloud server 14 generates a simple log of the designated peripheral device 30 based on the state information and the analysis information saved in the database 81 for each peripheral device 30.

In step S92, the cloud server 14 executes a simple log display request process. The cloud server 14 requests the maintenance terminal 16 as the order source to cause the display screen of the maintenance terminal 16 to display the simple log of the designated peripheral device 30.

In step S89, the maintenance terminal 16 executes a simple log display process. Upon receiving the simple log display request from the cloud server 14, the maintenance terminal 16 causes the display screen to display the simple log based on the simple log information received from the cloud server 14 together with the request.

### Detailed Log Acquisition Process

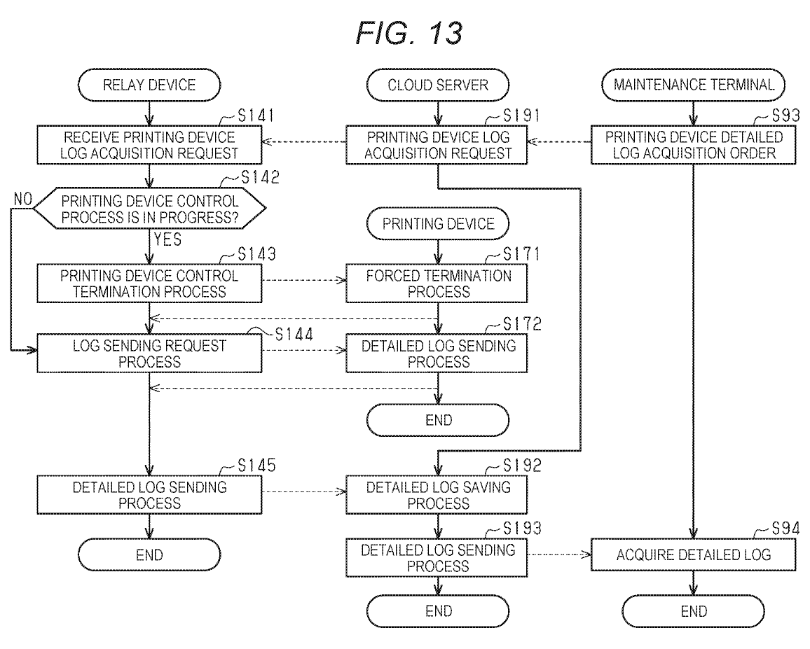

Next, the detailed log acquisition process will be described with reference to FIG. 13. For example, a detailed log is acquired if the cause of the failure is not known from the simple log or if submission is necessary when the manufacturer or the like is ordered to recover. Among the peripheral devices 30, for example, the printing device 33 can be caused to acquire the detailed log.

In step S93, the maintenance terminal 16 executes a printing device detailed log acquisition order. The maintenance person operates the input unit of the maintenance terminal 16 to order acquisition of the detailed log. Then, the maintenance terminal 16 executes a detailed log acquisition order process of ordering the cloud server 14 to generate a detailed log.

In step S191, the cloud server 14 executes a printing device log acquisition request. The cloud server 14 requests the relay device 12 to acquire the detailed log of the printing device 33.

In step S141, the control unit 20 receives the printing device log acquisition request. The control unit 20 receives the request for acquiring log information on the printing device 33 from the cloud server 14.

In step S142, the control unit 20 determines whether the printing device control process is in progress. The control unit 20 determines whether the printing device 33 is performing the control process. The control unit 20 proceeds to step S143 if the printing device 33 is performing the control process, and proceeds to step S144 if the printing device 33 is not performing the control process.

In step S143, the control unit 20 executes a printing device control termination process. The control unit 20 executes a process of ending the control of the printing device 33 during the control process. Specifically, the maintenance function unit 70 causes the command issuing unit 65 to issue a forced termination command, which is an example of a maintenance command. The transmission unit 56 transmits the forced termination command issued by the command issuing unit 65 to the printing device 33. The command issuing unit 65 may issue a forced termination command as a unique command that can be interpreted by the printing device 33, or may issue a forced termination command as a common command. If a forced termination command is issued as a common command, the command conversion unit 54 converts the forced termination command from a common command to a unique command that can be interpreted by the printing device 33, and then the transmission unit 56 transmits the forced termination command including the unique command to the printing device 33.

In step S171, the printing device 33 executes a forced termination process. The printing device 33 forcibly ends the control in process according to the instruction of the received forced termination command. In this way, the printing device 33 can receive the log acquisition command. The printing device 33 that forcibly terminates the control during the process notifies the relay device 12 that the forced termination is completed. The forced termination completion notification corresponds to an example of a maintenance process completion notification.

In step S144, the control unit 20 executes a log sending request process. The control unit 20 requests sending a log by sending a log acquisition command, which is an example of a maintenance command, to the printing device 33. Specifically, the log acquisition unit 73 of the maintenance function unit 70 causes the command issuing unit 65 to issue a log acquisition command. The transmission unit 56 transmits the log acquisition command issued by the command issuing unit 65 to the printing device 33. The command issuing unit 65 may issue a log acquisition command as a unique command that can be interpreted by the printing device 33, or may issue a log acquisition command as a common command. If a log acquisition command is issued as a common command, the command conversion unit 54 converts the log acquisition command from a common command to a unique command that can be interpreted by the printing device 33, and then the transmission unit 56 transmits the log acquisition command including the unique command to the printing device 33.

In step S172, the printing device 33 executes a detailed log sending process. The printing device 33 sends the log information to the relay device 12 according to the instruction of the received log acquisition command. Here, the log information from the printing device 33 is detailed log information recording the operation of the printing device 33. In other words, the detailed log information is more detailed than the simple log generated by the simple log generation unit 82 based on the analysis information acquired by the analysis unit 62 from the analysis result of the analysis target information including the command or the state information (status information) as the determination result of the determination unit 63. The detailed log information is an example of outcome information that the printing device 33 sends to the relay device 12 as a response to the log acquisition command.

In step S145, the control unit 20 executes a detailed log sending process. Specifically, the log acquisition unit 73 transmits the detailed log information acquired from the printing device 33 to the cloud server 14.

In step S192, the cloud server 14 executes a detailed log saving process. The cloud server 14 saves the detailed log information received from the relay device 12 in the database 81 or a predetermined storage area of the storage unit.

In step S193, the cloud server 14 executes a detailed log sending process. More specifically, the cloud server 14 sends the detailed log information to the maintenance terminal 16.

In step S94, the maintenance terminal 16 acquires a detailed log. The maintenance terminal 16 receives and acquires the detailed log information from the cloud server 14. The maintenance terminal 16 causes the display unit to display the detailed log based on the acquired detailed log information. Here, the display unit of the maintenance terminal 16 corresponds to an example of an output unit for outputting the outcome information.

The maintenance person can easily specify the cause of the failure from the detailed log of the printing device 33. If the call center acquires a detailed log, the call center passes the detailed log to the field engineer as mail, chat, or printed matter. The field engineer can easily specify the cause of the failure from the information on the detailed log. In addition, the maintenance person on the store side may acquire the detailed log information from the maintenance terminal 16. For example, if the cause of the failure is that the firmware of the printing device 33 has not been updated, or if the cause of the failure is a failure of a type that can be solved by updating the firmware of the printing device 33, the field engineer or the maintenance person on the store side attempts to update the firmware of the printing device 33. In the present embodiment, the firmware of the printing device 33 can be updated by remote control from the maintenance terminal 16.

### Firmware Update Process

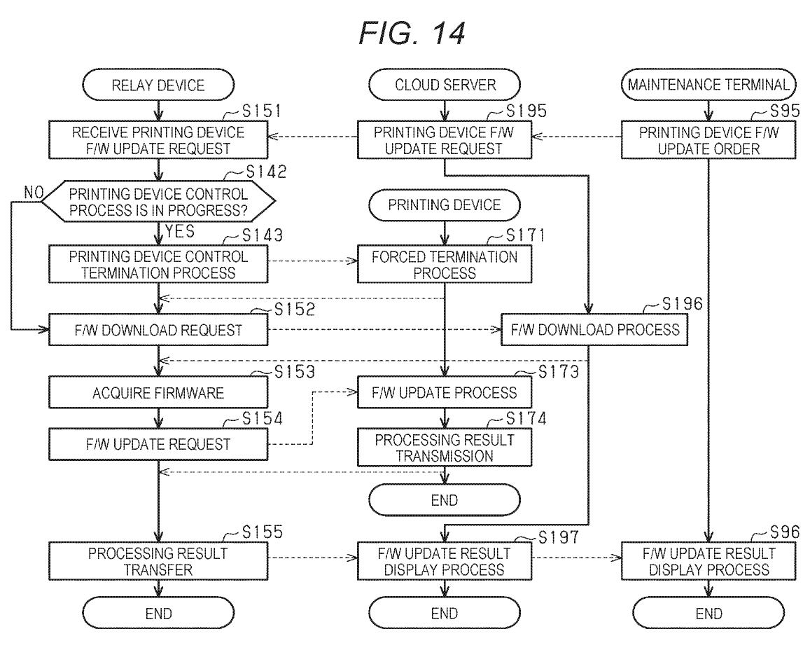

Next, a firmware update process will be described with reference to FIG. 14. In FIG. 14, the firmware is described as "F/W".

In step S95, the maintenance terminal 16 executes a printing device firmware update order. The maintenance person operates the input unit of the maintenance terminal 16 to order the update of the firmware of the printing device 33. Then, the maintenance terminal 16 executes a firmware update order process of ordering the cloud server 14 to update the firmware of the printing device 33.

In step S195, the cloud server 14 executes a printing device firmware update request. The cloud server 14 requests the relay device 12 to update the firmware of the printing device 33.

In step S151, the control unit 20 receives the printing device firmware update request. The control unit 20 receives the firmware update request for the printing device 33 from the cloud server 14.

In step S142, the control unit 20 determines whether the printing device control process is in progress. This determination process is the same process as step S142 illustrated in FIG. 13. The control unit 20 determines whether the printing device 33 is performing the control process. The control unit 20 proceeds to step S143 if the printing device 33 is performing the control process, and proceeds to step S152 if the printing device 33 is not performing the control process.

In step S143, the relay device 12 executes a printing device control termination process. This control termination process is the same process as step S143 illustrated in FIG. 13. The control unit 20 executes a process of ending the control of the printing device 33 during the control process. Specifically, the maintenance function unit 70 causes the command issuing unit 65 to issue a forced termination command, which is an example of a maintenance command. The transmission unit 56 transmits the forced termination command issued by the command issuing unit 65 to the printing device 33.

In step S171, the printing device 33 executes a forced termination process. This forced termination process is the same process as step S171 illustrated in FIG. 13. The printing device 33 forcibly ends the control in process according to the instruction of the received forced termination command. The printing device 33 notifies the relay device 12 that forced termination is completed. The forced termination completion notification is an example of a maintenance process completion notification.

In step S152, the control unit 20 executes a firmware download request. The control unit 20 requests the cloud server 14 to download the firmware.

In step S196, the cloud server 14 executes a firmware download process. The cloud server 14 executes a process of downloading the latest firmware of the printing device 33 to the relay device 12 as a response to the download request from the relay device 12.

In step S153, the control unit 20 acquires the firmware. The control unit 20 acquires the firmware of the printing device 33 downloaded from the cloud server 14.

In step S154, the control unit 20 executes a firmware update request. The control unit 20 requests update of firmware by sending an update command, which is an example of a maintenance command, to the printing device 33. Specifically, the update unit 72 of the maintenance function unit 70 causes the command issuing unit 65 to issue an update command. The transmission unit 56 transmits the update command issued by the command issuing unit 65 to the printing device 33. At this time, the update unit 72 causes the transmission unit 56 to transmit the latest firmware previously acquired by the download together with the update command. The command issuing unit 65 may issue an update command as a unique command that can be interpreted by the printing device 33, or may issue an update command as a common command. If an update command is issued as a common command, the command conversion unit 54 converts the update command from a common command to a unique command that can be interpreted by the printing device 33, and then the transmission unit 56 transmits the update command including the unique command to the printing device 33.

In step S173, the printing device 33 executes a firmware update process. The printing device 33 updates the firmware to the latest firmware according to the instruction of the received update command.

In step S174, the printing device 33 executes processing result transmission. After updating the firmware, the printing device 33 notifies the relay device 12 of a processing result indicating that the update of the firmware has been successfully completed.

In step S155, the control unit 20 executes processing result transfer. The control unit 20 transfers the processing result indicating that the update of the firmware has been successfully completed to the cloud server 14.

In step S197, the cloud server 14 executes a firmware update result display process. The cloud server 14 requests the maintenance terminal 16 to perform a display process of causing the maintenance terminal 16 to display the firmware update result.

In step S96, the maintenance terminal 16 executes a firmware update result display process. The maintenance terminal 16 causes the display unit to display the firmware update result according to the firmware update result display process request from the cloud server 14. The display of the firmware update result corresponds to an example of a maintenance process completion notification. The display unit of the maintenance terminal 16 corresponds to an example of an output unit that outputs a maintenance process completion notification that is completion information indicating that the maintenance process has been completed.

In this way, the maintenance person can update the firmware of the printing device 33 by remote control from the maintenance terminal 16 without going to the store. If the POS system 11 is recovered from the failure by updating the firmware, a maintenance person such as a field engineer does not need to go to the store for the recovery work of the POS system 11. In addition, the maintenance person on the store side in the chain store does not need to go to the chain store in which the POS system 11 in which the failure has occurred is present. That is, in both cases of the on-site maintenance service and the send-back maintenance service, the maintenance person can specify the cause of the failure early via the cloud server 14 or the maintenance terminal 16. Furthermore, because maintenance processes such as updating the firmware of the printing device 33 can be performed by remote control, the POS system 11 can be recovered without going to the store. This reduces the frequency of the maintenance person going to the store for the recovery work of the POS system 11. The occurrence of a failure of the POS system 11 can also be prevented by updating the firmware of the printing device 33 by remote control as maintenance other than when a failure occurs in the POS system 11.

According to the embodiment, effects described below can be obtained.

(1-1) The relay device 12 of the POS system 11 is configured to relay communication between the terminal device 15 capable of executing an accounting process and the one or more peripheral devices 30. The relay device 12 includes: the transmission unit 56 for transmitting request information to any of the peripheral devices 30; and the reception unit 57 for receiving response information from any of the peripheral devices 30. The relay device 12 includes: the analysis unit 62 for analyzing the analysis target information to be analyzed among the request information and the response information; and the determination unit 63 for determining the state of any of the peripheral devices 30 based on the analysis result of the analysis unit 62. According to this configuration, the relay device 12 determines the state of the peripheral device 30 from the analysis result of the analysis target information among the request information and the response information. The determination information acquired from the relay device 12 is useful for recovery when a failure occurs in the peripheral device 30. This can shorten the failure recovery time of the POS system 11 as compared with before.

(1-2) If the state of any of the peripheral devices 30 is abnormal, the determination unit 63 determines the abnormal state in a plurality of stages according to the difference in degree of importance. According to this configuration, the state of abnormality of the peripheral device 30 can be determined for each degree of importance. This can shorten the failure recovery time of the POS system 11 as compared with before. For example, it is possible to reduce a delay in recovery response due to overlooking of an important determination result, and waste due to excessive response to an unimportant determination result.

(1-3) The relay device 12 includes a notification unit for notifying the server 14 of the determination result of the determination unit 63 via the network. According to this configuration, since the server 14 on the network is notified of the result of determination by the determination unit 63, the state of the peripheral device 30 can be known even from a remote location away from the POS system 11. It is also possible to know the state of the peripheral device 30 from a terminal connected to the server 14. This can shorten the failure recovery time of the POS system 11 as compared with before.

(1-4) The command included in the request information is a common command, and the command included in the response information is a unique command specific to any of the peripheral devices 30. The relay device 12 includes: the command conversion unit 54; the first port 40 that allows the terminal device 15 to be connected; the second ports 41, 42 that allow the peripheral device 30 to be connected; and the monitoring unit 61. The command conversion unit 54 converts the common command into the unique command before transmitting the request information to any of the peripheral devices 30, and converts the response information from any of the peripheral devices 30 from the unique command into the common command. The monitoring unit 61 monitors and acquires analysis target information from an information group transmitted between the first port 40 and the second ports 41, 42. The monitoring unit 61 monitors and acquires the analysis target information including the common command. The analysis unit 62 analyzes the analysis target information including the common command. According to this configuration, in the POS system 11 of the command conversion type, the analysis unit 62 analyzes the common command. Therefore, the analysis processing time can be reduced as compared with a configuration in which a unique command specific to the peripheral device 30 is analyzed.

(1-5) The relay device 12 may include the communication unit 43, the failure detection unit 71, and the abnormality notification unit 74. The communication unit 43 is communicably connected to the server 14 or the maintenance terminal 16. The failure detection unit 71 detects a failure of any of the peripheral devices 30 based on the analysis result of the analysis unit 62 or the determination result of the determination unit 63. When the failure detection unit 71 detects a failure, the abnormality notification unit 74 notifies the server 14 or the maintenance terminal 16 of the abnormality of a corresponding peripheral device 30. According to this configuration, since the server 14 or the maintenance terminal 16 is notified of the abnormality in which a failure has occurred in the peripheral device 30 via the network, it is possible to know the failure of the peripheral device 30 at an early stage. Therefore, it is possible to quickly cope with the failure of the peripheral device 30.

(1-6) At least one of the peripheral devices 30 is the printing device 33. The relay device 12 includes: the command issuing unit 65 for issuing commands that can be interpreted by the printing device 33; and the maintenance function unit 70 for, upon receiving a maintenance request, causing the command issuing unit 65 to issue a maintenance command to cause the printing device 33 to perform the maintenance process. According to this configuration, it is possible to send the maintenance request to the relay device 12, thereby causing the printing device 33 to perform the maintenance process. Therefore, it is possible to cause the printing device 33 to perform the maintenance process, thereby leading to early recovery from the failure or resolving the failure of the peripheral device 30 without going to the store.

(1-7) At least one of the peripheral devices 30 is the printing device 33. The relay device 12 includes: the command issuing unit 65 for issuing a command that can be interpreted by the printing device 33; and the update unit 72 for, upon receiving an update request, causing the command issuing unit 65 to issue an update command for causing the printing device 33 to update the firmware. According to this configuration, it is possible to send the update request to the relay device 12, thereby updating the firmware of the printing device 33 connected to the relay device 12. For example, by sending an update request to the relay device 12 by remote control, it is possible to update the firmware of the printing device 33 without going to the store.

(1-8) At least one of the peripheral devices 30 is the printing device 33. The relay device 12 includes: the command issuing unit 65 for issuing a command that can be interpreted by the printing device 33; and the log acquisition unit 73 for, upon receiving a log acquisition request, causing the command issuing unit 65 to issue a log acquisition command for causing the printing device 33 to acquire log information. According to this configuration, it is possible to send a log acquisition request to the relay device 12 to acquire log information on the printing device 33. For example, by sending a log acquisition request to the relay device 12 by remote control, it is possible to acquire the log information on the printing device 33 without going to the store.

(1-9) Upon receiving a forced termination request for the printing device 33 as the maintenance request, the maintenance function unit 70 causes the command issuing unit 65 to issue a forced termination command for forcibly terminating the printing device 33. According to this configuration, the printing device 33 can be forcibly terminated by sending the forced termination request to the relay device 12 as the maintenance request. For example, by sending a forced termination request to the relay device 12 by remote control, it is possible to forcibly terminate the printing device 33 without going to the store. Therefore, the printing device 33 can be maintained without going to the store.

(1-10) The POS system 11 includes: the relay device 12 for relaying between the terminal device 15 that can execute the accounting process and the one or more peripheral devices 30; and the server 14 that can connect to the relay device 12 via a network. The relay device 12 includes: the transmission unit 56 for transmitting request information to any of the peripheral devices 30; and the reception unit 57 for receiving response information from any of the peripheral devices 30. The relay device 12 or the server 14 includes: the analysis unit 62 for analyzing the analysis target information to be analyzed among the request information and the response information; and the determination unit 63 for determining the state of any of the peripheral devices 30 based on the analysis result of the analysis unit 62.

This configuration uses the determination information acquired from the relay device 12 or the server 14 to specify a failure of the peripheral device 30, thereby shortening the failure recovery time of the POS system 11 as compared with before. For example, by providing the analysis unit 62 and the determination unit 63 in the server 14, the storage unit 21 (memory) of the relay device 12 can be saved. In addition, the server 14 often has abundant memory, and has a higher performance of the CPU and the like. If the analysis unit 62 and the determination unit 63 are provided in the server 14, the command analysis and the determination can be performed in detail and deeply, and thus a particularly remarkable effect can be obtained.

(1-11) In the POS system 11, the relay device 12 includes the analysis unit 62. According to this configuration, the command acquired by the relay device 12 can be analyzed in situ. It is not necessary to transfer a command outside the relay device 12 for analysis. Therefore, it is easy to determine the state of the peripheral device 30 based on the analysis result with little delay.

(1-12) The POS system 11 includes: the abnormality detection unit for detecting an abnormality of any of the peripheral devices 30 based on the analysis result of the analysis unit 62 or the determination result of the determination unit 63; and the abnormality notification unit 74 for, when the abnormality detection unit detects an abnormality, notifying the maintenance terminal 16 connected to the server 14 of information indicating that a corresponding peripheral device 30 is abnormal. The abnormality detection unit is provided in the relay device 12 or the server 14. The abnormality notification unit 74 is provided in the relay device 12 or the server 14. According to this configuration, when an abnormality of the peripheral device 30 is detected, the maintenance terminal 16 connected to the server 14 is notified of information indicating that the peripheral device 30 is abnormal, which allows the maintenance person or the like to know the abnormality of the POS system 11 even from a remote location. By providing the abnormality notification unit 74 in the relay device 12, the notification of the abnormality notification unit 74 may be configured such that the server 14 acquires the detection result indicating the abnormality from the relay device 12 through the web API, so that the relay device 12 notifies the server 14 of the information indicating the abnormality.

(1-13) At least one of the peripheral devices 30 is the printing device 33. The POS system 11 includes: the command issuing unit 65 that can issue commands; and the maintenance function unit 70 for, upon receiving a maintenance request to the printing device 33, causing the command issuing unit 65 to issue a maintenance command for the printing device 33 to cause the printing device 33 to perform a maintenance process according to the maintenance request. The command issuing unit 65 is provided in the relay device 12 or the server 14. The maintenance function unit 70 is provided in the relay device 12 or the server 14. According to this configuration, by sending a maintenance request for the printing device 33 to the relay device 12 or the server 14, it is possible to cause the printing device 33 to perform the maintenance process by remote control.

(1-14) The POS system 11 includes the terminal device 15 capable of executing an accounting process and the one or more peripheral devices 30. The server 14 is communicably connected to the relay device 12 for relaying the terminal device 15 and the peripheral devices 30. The relay device 12 includes a transmission unit 56 for transmitting request information to the peripheral device 30 and a reception unit 57 for receiving response information from the peripheral device 30. The server 14 includes: the analysis unit 62 for analyzing the analysis target information to be analyzed among the request information and the response information; and the determination unit 63 for determining the state of any of the peripheral devices 30 based on the analysis result of the analysis unit 62. According to this configuration, the relay device 12 determines the state of the peripheral device 30 from the analysis result of the analysis target information among the request information and the response information. Therefore, the determination information acquired from the relay device 12 is useful for specifying a failure of the peripheral device 30, thereby shortening the failure recovery time of the POS system 11 as compared with before.

(1-15) The server 14 of the POS system 11 is connected to the maintenance terminal 16 through a network. The server 14 accumulates the analysis result of the analysis unit 62 or the determination result of the determination unit 63 as a database. The server 14 includes the simple log generation unit 82 for, when receiving a simple log generation request from the maintenance terminal 16, generating a simple log of any of the peripheral devices 30 based on the database. According to this configuration, by sending a simple log generation request from the maintenance terminal 16 to the server 14, it is possible to acquire a simple log of the peripheral device 30. Therefore, it is easy to specify the cause of the failure of the POS system 11.

(1-16) The POS system 11 includes the terminal device 15 capable of executing an accounting process, the one or more peripheral devices 30, and the relay device 12 for relaying the terminal device 15 and the peripheral devices 30. The relay device 12 includes a transmission unit 56 for transmitting request information to the peripheral device 30 and a reception unit 57 for receiving response information from the peripheral device 30. The maintenance method for the POS system 11 for maintaining the peripheral devices 30 includes the following (A1) and (A2).

(A1) Analyze the analysis target information to be analyzed among the request information and the response information.

(A2) Acquire maintenance information available for maintaining the peripheral device 30 based on the analysis result of the analysis target information, and output the maintenance information to an output unit of a device capable of communicating with the relay device 12. According to this method, the maintenance information available for maintenance of the peripheral device 30 is output to the output unit of the device capable of communicating with the relay device 12. Therefore, by using the maintenance information, for example, it is easy to specify the failure of the peripheral device 30, and the failure recovery time of the POS system 11 is shortened compared with before. For example, by outputting the maintenance information from the output unit of a device located at a remote location away from the POS system 11, it is easy to specify the cause of the failure of the peripheral device 30 at an early stage without going to the store.

(1-17) The POS system 11 includes the terminal device 15 capable of executing an accounting process, the one or more peripheral devices 30, and the relay device 12 for relaying the terminal device 15 and the peripheral devices 30. The relay device 12 includes a communication unit 43 communicably connected to the server 14 or the maintenance terminal 16, a transmission unit 56 for transmitting request information to the peripheral devices 30, and a reception unit 57 for receiving response information from the peripheral devices 30. The maintenance method for the POS system 11 includes the following (B1) to (B3).

(B1) Analyze the analysis target information to be analyzed among the request information and the response information.

(B2) Detect an abnormality of the peripheral device 30 based on the analysis result of the analysis target information.

(B3) Upon detecting an abnormality, notify the server 14 or the maintenance terminal 16 of information indicating that the peripheral device 30 is abnormal.

According to this method, since the maintenance person or the like is notified of the abnormality of the peripheral device 30 via the server 14 or the maintenance terminal 16, the maintenance person or the like can know the abnormality occurring in the peripheral device 30 at an early stage. Therefore, since the recovery response at the time of occurrence of a failure or the like can be started early, the POS system 11 can be easily recovered earlier than before.

(1-18) The POS system 11 includes the terminal device 15 capable of executing an accounting process, the one or more peripheral devices 30, and the relay device 12 for relaying the terminal device 15 and the peripheral devices 30. The relay device 12 includes a communication unit 43 communicably connected to the server 14 or the maintenance terminal 16, a transmission unit 56 for transmitting request information to the peripheral devices 30, and a reception unit 57 for receiving response information from the peripheral devices 30. The maintenance method for the POS system 11 includes the following (C1) to (C4).

(C1) Upon detecting an abnormality of the printing device 33 based on the analysis result obtained by analyzing the analysis target information to be analyzed among the request information and the response information, notify the server 14 or the maintenance terminal 16 of information indicating the abnormality.

(C2) Upon receiving a maintenance request for the printing device 33 from the server 14 or the maintenance terminal 16, issue a maintenance command corresponding to the maintenance request and transmit the maintenance command to the printing device 33.

(C3) The printing device 33 executes a maintenance process instructed by the maintenance command.

(C4) Upon receiving outcome information on the maintenance process or completion information on the maintenance process from the printing device 33, send the outcome information or the completion information to the server 14 or the maintenance terminal 16.

According to this method, it is possible to know an abnormality of the printing device 33 even from a remote location away from the POS system 11, and to cause the printing device 33 to perform the maintenance process by remote control. Examples of the maintenance request include a log acquisition request, a firmware update request, and a forced termination request. Examples of the maintenance command include a log acquisition command, a firmware update command, and a forced termination command. Examples of the outcome information include log information. The completion information includes an update completion notification, a forced termination completion notification, and the like. The forced termination command here includes a simple forced termination command for simply instructing only the forced termination process, and a restart command for instructing both the forced termination process and an activation process.

### Second Embodiment

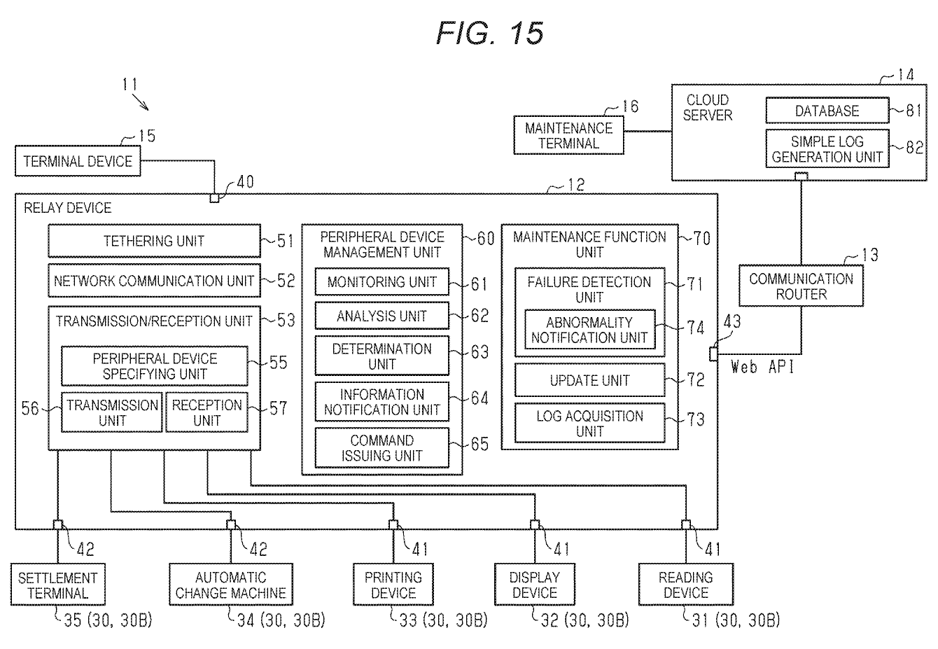

Next, a POS system 11 according to a second embodiment will be described with reference to FIGS. 15 to 20. In the second embodiment, the relay device does not have a command conversion function. An OPOS command is used as the common command. The peripheral devices can support an OPOS command. The POS system according to the second embodiment is basically the same as that of the first embodiment except that the command conversion function is not provided. In the following description, components basically common to those of the first embodiment are denoted by the same reference signs, and description thereof will be omitted or simplified. Hereinafter, differences from the first embodiment will be described in detail.

The POS system 11 according to the second embodiment is of a driver control type in which the peripheral device 30 is controlled by a predetermined operating system installed in the terminal device 15 and a common command from a driver operating on the predetermined operating system. That is, the terminal device 15 is installed with a predetermined operating system and a driver operating on the predetermined operating system.

The predetermined operating system is "Windows (registered trademark) OS" or "Linux (registered trademark)". The driver installed in the terminal device 15 operates on the operating system. If the predetermined operating system is Windows OS, the driver operates on Windows OS. If the predetermined operating system is Linux, the driver operates on Linux. If the predetermined operating system is Windows OS, Open POS (OPOS), which is a unified standard operating on Windows OS, may be used. In this case, an OPOS driver is used as the driver. The command is a common command, for example, an OPOS command.

The basic configuration is the same as in the first embodiment, although there is a difference in configuration due to the control method of the POS system 11 being of a driver control type. The POS system 11 according to the second embodiment has the same configuration as that illustrated in FIG. 1. That is, the POS system 11 includes a terminal device 15, a relay device 12, and a peripheral device 30. The POS system 11 may further include a cloud server 14, which is an example of a server connected to the relay device 12 via a network NW. The relay device 12 includes a control unit 20, a storage unit 21, and a communication interface 22. The storage unit 21 stores a program PR. The second embodiment does not include the command conversion unit 54 included in the relay device 12 according to the first embodiment. Therefore, the storage unit 21 illustrated in FIG. 1 does not store the conversion table CT.

Next, the configuration of the POS system 11 according to the second embodiment will be described with reference to FIG. 15. As illustrated in FIG. 15, the POS system 11 of the driver control type uses common commands. The transmission/reception unit 53 does not include a command conversion unit. The transmission/reception unit 53 includes a peripheral device specifying unit 55, a transmission unit 56, and a reception unit 57. Other configurations are the same as those of the first embodiment. That is, in addition to the transmission/reception unit 53, the relay device 12 includes a tethering unit 51, a network communication unit 52, a peripheral device management unit 60, and a maintenance function unit 70. As in the first embodiment, the peripheral device management unit 60 includes the monitoring unit 61, the analysis unit 62, the determination unit 63, the information notification unit 64, and the command issuing unit 65. The maintenance function unit 70 includes a failure detection unit 71, an update unit 72, a log acquisition unit 73, and an abnormality notification unit 74.

The peripheral device 30 is installed with a predetermined operating system similar to that installed in the terminal device 15, that is, Windows OS or Linux. Each peripheral device 30 is controlled by a driver operating on Windows OS or Linux in the terminal device 15. Each driver is activated when the accounting processing application in the terminal device 15 is activated. When the user performs an accounting process operation on the terminal device 15, the driver for controlling the peripheral device 30 to be controlled corresponding to the operation operates.

As illustrated in FIG. 15, the relay device 12 includes a first port 40 and second ports 41, 42 as in the first embodiment. The first port 40 is a port that allows the terminal device 15 to be connected. The second ports 41, 42 are ports for connecting the peripheral device 30. The first port 40 is an upstream port to which a request for the accounting process is issued. The second ports 41, 42 are ports that are downstream in the accounting process and allow the peripheral device 30 to be connected. The first port 40 and the second port 41 are, for example, USB ports. The second port 42 is, for example, a serial port. The relay device 12 also includes a communication unit 43 communicably connected to the cloud server 14 or the maintenance terminal 16. A communication router 13 is connected to the communication unit 43. The relay device 12 is communicably connected to the cloud server 14 and the maintenance terminal 16 via the communication router 13. By connecting to the cloud server 14, the maintenance terminal 16 can perform a maintenance process and the like on the relay device 12 by remote control.

The transmission unit 56 performs a distribution operation of distributing request information including a transmitted command described in a common command language to a port to which the peripheral device 30 as the transmission target is connected. That is, the transmission unit 56 performs a distribution operation of distributing the transmitted command including the common command to the port to which the peripheral device 30 as the transmission target is connected. The reception unit 57 receives response information described in the common command language from each peripheral device 30 from the second ports 41, 42.

The monitoring unit 61 monitors the information group transmitted between the first port 40 and the second ports 41, 42 to acquire the analysis target information to be analyzed among the request information and the response information. The analysis target information includes a common command. The common command includes a command described in the common command language and data accompanying the command. The analysis target information may include a command and data, or may be only a command without including data. The analysis target information may include data only for a specific command. In the present embodiment, similarly to the first embodiment, the monitoring unit 61 acquires all the request information and the response information exchanged during the accounting process as the analysis target information, but may acquire only a predetermined part of the request information and the response information as the analysis target information.

The analysis unit 62 analyzes the analysis target information acquired by the monitoring unit 61. The analysis unit 62 analyzes the request information including the common command acquired by the monitoring unit 61 as the analysis target information. The analysis unit 62 analyzes the response information described in the common command language acquired by the monitoring unit 61 as the analysis target information.

The second embodiment includes the same maintenance method for the POS system 11 as the first embodiment. That is, the second embodiment includes the first maintenance method, the second maintenance method, and the third maintenance method. Further, the second embodiment provides the same program PR as that of the first embodiment. The program PR according to the second embodiment includes the first program PR, the second program PR, and the third program PR similar to those of the first embodiment. The program PR is provided in a form stored in a storage medium. The program PR may be provided by downloading from a server such as the cloud server 14.

### Operation of Second Embodiment

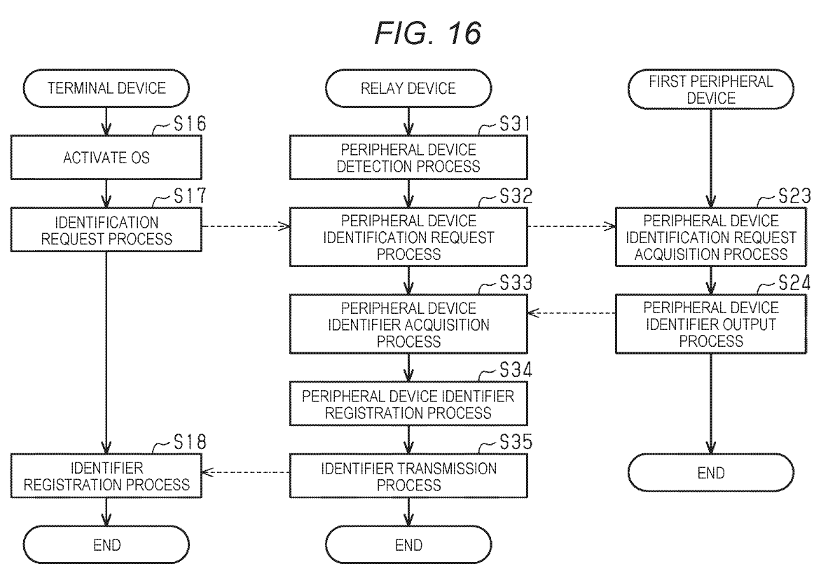

The operation of the relay device 12 configured as described above, the POS system 11 including the relay device 12, and the cloud server 14, which is an example of a server, are described next with reference to FIGS. 16 to 20. In the state determination / failure detection process (FIG. 9) and the maintenance process (FIGS. 12 to 14), the relay device 12, the cloud server 14, and the maintenance terminal 16 basically execute the same processes as in the first embodiment. The maintenance process includes a simple log generation process (FIG. 12), a detailed log acquisition process (FIG. 13), and a firmware update process (FIG. 14). These processes are basically the same as those in the first embodiment.

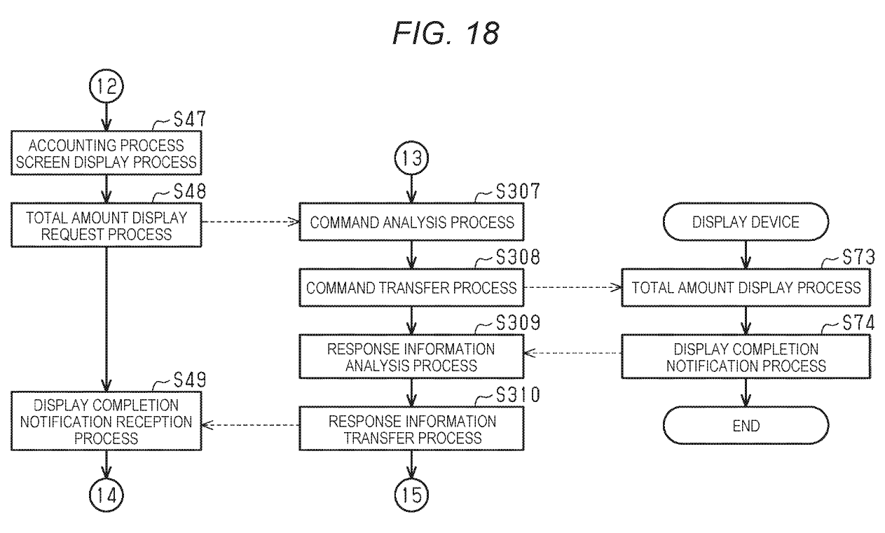

Hereinafter, the peripheral device identification process (FIG. 16) and the accounting control process (FIGS. 18 to 20) will be described. Regarding the processes the same as or similar to those of the first embodiment, the description thereof will be omitted or only the differences will be described. In FIGS. 16 to 20, the same step numbers are given to the same processes as those in the first embodiment. Description of processes having step numbers common to the first embodiment will be omitted or simplified.

### Peripheral Device Identification Process

The peripheral device identification process will be described with reference to FIG. 16. The peripheral device identification process is a process executed by the terminal device 15 and the relay device 12 when the operating system of the terminal device 15 is activated. The peripheral device identification process is a process executed by the control unit 20 in response to a request from the terminal device 15 while the peripheral device 30 is electrically connected to the relay device 12. The second embodiment is different from the first embodiment in that the terminal device 15 is the subject of control. A user such as a store clerk performs an ON operation of turning on the terminal device 15.

As illustrated in FIG. 16, in step S16, the terminal device 15 activates the operating system. The terminal device 15 activates, for example, Windows OS or Linux.

In step S17, the terminal device 15 executes an identification request process. In this process, the terminal device 15 transmits an identification request to the relay device 12.

The processes of step S32 to step S34 and steps S23 and S24 are the same as those of the first embodiment. That is, in step S32, the control unit 20 executes a peripheral device identification request process.

In step S23, the peripheral device 30 executes a peripheral device identification request acquisition process. In the next step S24, the peripheral device 30 executes a peripheral device identifier output process.

In step S33, the control unit 20 executes a peripheral device identifier acquisition process. In this process, the control unit 20 receives the peripheral device identifier from the connected peripheral device 30.

In step S34, the control unit 20 executes a peripheral device identifier registration process. In this process, the control unit 20 registers the acquired peripheral device identifier in the storage unit 21. In particular, the control unit 20 registers the connection port at which the peripheral device 30 is connected to the relay device 12 and the peripheral device identifier in the storage unit 21 in association with each other. Accordingly, the control unit 20 can identify the peripheral device 30 connected to the relay device 12. Specifically, the peripheral device specifying unit 55 (see FIG. 15) registers the connection port and the peripheral device identifier in association with each other.

In step S35, the control unit 20 executes an identifier transmission process. In this process, the control unit 20 transmits the peripheral device identifier from the peripheral device 30 and the relay device identifier, which is the identifier of the relay device 12 itself, to the terminal device 15. The control unit 20 reads and acquires the relay device identifier stored in the storage unit 21 of the relay device 12.

In step S18, the terminal device 15 executes an identifier registration process. In this process, the terminal device 15 registers the peripheral device identifier and the relay device identifier in the storage unit. Accordingly, the terminal device 15 can identify the relay device 12 and the peripheral device 30.

### Accounting Control Process

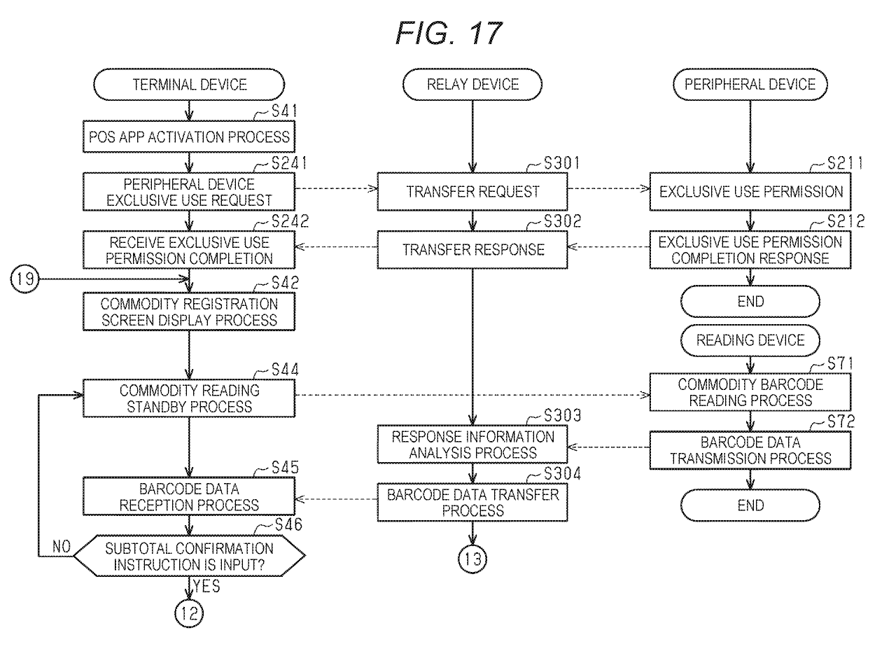

Next, an accounting control process according to the second embodiment will be described with reference to FIGS. 17 to 20.

In step S41, the terminal device 15 activates the POS app.

In the next step S241, the terminal device 15 executes a peripheral device exclusive use request. For example, the terminal device 15 may separately execute the peripheral device exclusive use request for the first peripheral device 30A and the second peripheral device 30B in accordance with a difference in the type of the connection port.

In step S301, the control unit 20 transfers the request. That is, the control unit 20 transfers the peripheral device exclusive use request to each peripheral device 30 as it is.

In step S211, each peripheral device 30 executes exclusive use permission.

In step S212, each peripheral device 30 executes an exclusive use permission completion response.

In step S302, the control unit 20 transfers the request. That is, the control unit 20 transfers the exclusive use permission completion response from each peripheral device 30 to the terminal device 15 as it is.

In step S242, the terminal device 15 receives exclusive use permission completion.

The processes of the next steps S42, S44, S71, and S72 are the same as those in the first embodiment.

In step S303, the control unit 20 executes a response information extraction process. In this process, the control unit 20 analyzes the response information including the transmitted command including the common command from the reading device 31 and the barcode data. The control unit 20 saves the analysis result in the storage unit 21.

In step S304, the control unit 20 executes a barcode data transfer process. In this process, the control unit 20 transfers the response information including the transmitted command and the barcode data from the reading device 31 to the terminal device 15.

The processing of step S45 and step S46 is the same as in the first embodiment. In this way, the control unit 20 analyzes the request information and the response information without performing command conversion.

If the subtotal confirmation instruction is input in step S46, the process proceeds to step S47 illustrated in FIG. 18. The terminal device 15 executes an accounting process screen display process (step S47) and a total amount display request process (step S48).

In step S307, the control unit 20 executes a command analysis process. In this process, the control unit 20 analyzes the display request command including the common command and the total amount data. The control unit 20 saves the analysis result in the storage unit 21.

In step S308, the control unit 20 executes a command transfer process. Since the display device 32, which is a peripheral device 30, can interpret a common command, the display device 32 transfers the request information as a common command.

The display device 32 sequentially executes a total amount display process (step S73) and a display completion notification process (step S74).

In step S309, the control unit 20 executes a response information analysis process. In this process, the control unit 20 analyzes the response information including the display completion notification command including the common command. The control unit 20 saves the analysis result in the storage unit 21.

In step S310, the control unit 20 executes a response information transfer process. In this process, the control unit 20 transfers response information including a display completion notification command including a common command to the terminal device 15.

In step S49, the terminal device 15 executes a display completion notification reception process.

### Cash Settlement Process

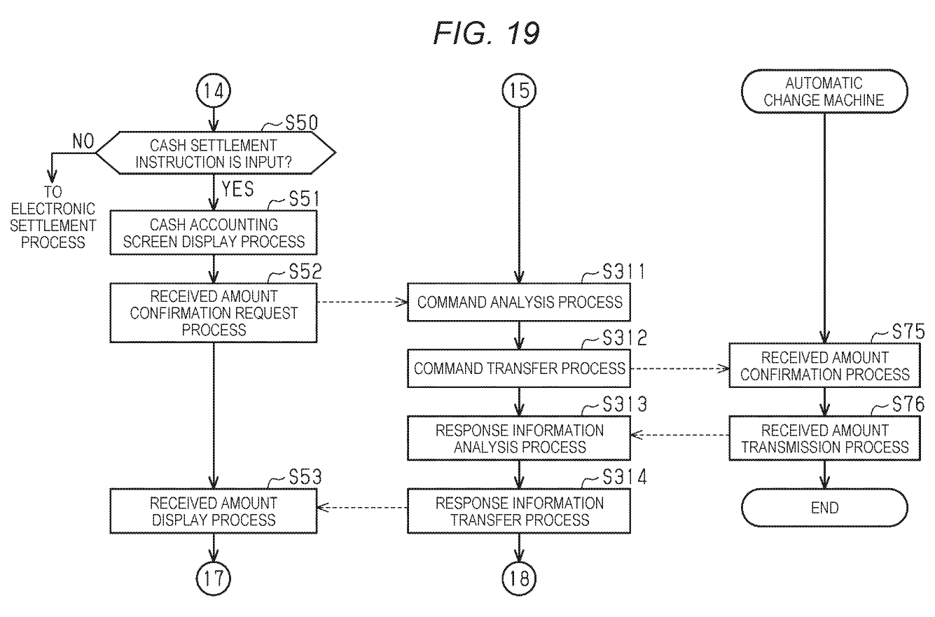

Subsequently, in step S50 illustrated in FIG. 19, the terminal device 15 determines whether a cash settlement instruction has been input. When a cash settlement instruction is input by the user selecting cash settlement with the denomination button, the terminal device 15 sequentially executes the cash accounting screen display process (step S51) and the received amount confirmation request process (step S52).

In step S311, the control unit 20 executes a command analysis process. In this process, the control unit 20 analyzes the request information including the received amount confirmation command including the common command. The control unit 20 saves the analysis result in the storage unit 21.

In step S312, the control unit 20 executes a command transfer process. In this process, the control unit 20 transfers request information including a received amount confirmation command including a common command to the automatic change machine 34.

The automatic change machine 34 sequentially executes a received amount confirmation process (step S75) and a received amount transmission process (step S76).

In step S313, the control unit 20 executes a response information analysis process. In this process, the control unit 20 analyzes the response information including the received amount data and the received amount transmission command including the common command. The control unit 20 saves the analysis result in the storage unit 21.

In step S314, the control unit 20 executes a response information transfer process. In this process, the control unit 20 transfers the request information including the received amount transmission command including the common command to the terminal device 15.

### Receipt Issuing Process

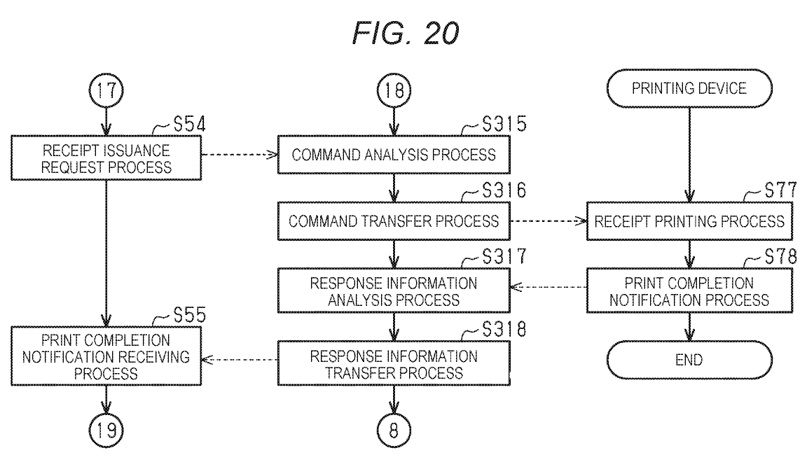

Next, in step S54 illustrated in FIG. 20, the terminal device 15 executes a receipt issuance request process.

In step S315, the control unit 20 executes a command analysis process. In this process, the control unit 20 analyzes the request information including the print data and the receipt issuing command including the common command. The control unit 20 saves the analysis result in the storage unit 21.

In step S316, the control unit 20 executes a command transfer process. In this process, the control unit 20 transfers request information including a receipt issuing command including a common command to the printing device 33.

The printing device 33 sequentially executes the receipt printing process (step S77) and the print completion notification process (step S78). In the print completion notification process, the printing device 33 transmits response information including a print completion command including a common command to the relay device 12.

In step S317, the control unit 20 executes a response information analysis process. In this process, the control unit 20 analyzes the response information including the print completion command including the common command. The control unit 20 saves the analysis result in the storage unit 21.

In step S318, the control unit 20 executes a response information transfer process. In this process, the control unit 20 transfers response information including a print completion command including a common command to the terminal device 15.

Hereinafter, in the electronic settlement process, the command conversion process in the first embodiment is omitted as well. Similarly to the cash settlement process illustrated in FIG. 20, the electronic settlement process is different from the first embodiment only in that the electronic settlement process includes a command analysis process, a command transfer process, a response information analysis process, and a response information transfer process, and thus the description thereof is omitted.

In addition, every time the receipt issuing process is completed, the state determination / failure detection process illustrated in FIG. 9 is executed as in the first embodiment. The simple log generation process illustrated in FIG. 12, the detailed log acquisition process illustrated in FIG. 13, and the firmware update process illustrated in FIG. 14 are the same as those in the first embodiment.

Therefore, according to the POS system 11 according to the second embodiment, although the control method of the POS system 11 is different from that of the first embodiment, the effects (1-1) to (1-18) of the first embodiment can be obtained in the same manner, and the following effects can be further obtained.

(2-1) The POS system 11 employs a driver control type in which the peripheral device 30 is controlled by a predetermined operating system installed in the terminal device 15 and a common command from a driver operating on the predetermined operating system. The relay device 12 employed in the POS system 11 of the driver control type includes a first port 40 that allows the terminal device 15 to be connected, second ports 41, 42 that allow the peripheral device 30 to be connected, and a monitoring unit 61. The monitoring unit 61 monitors and acquires analysis target information including a common command from an information group transmitted between the first port 40 and the second ports 41, 42. The analysis unit 62 analyzes the analysis target information including the common command acquired by the monitoring unit 61. According to this configuration, the analysis unit 62 may analyze the common command by adopting the relay device 12 in the POS system 11 of the driver control type. Therefore, the analysis processing time can be shortened compared to a configuration in which analysis target information including a unique command is analyzed by the POS system 11 using a unique command specific to the peripheral device 30.

### Third Embodiment

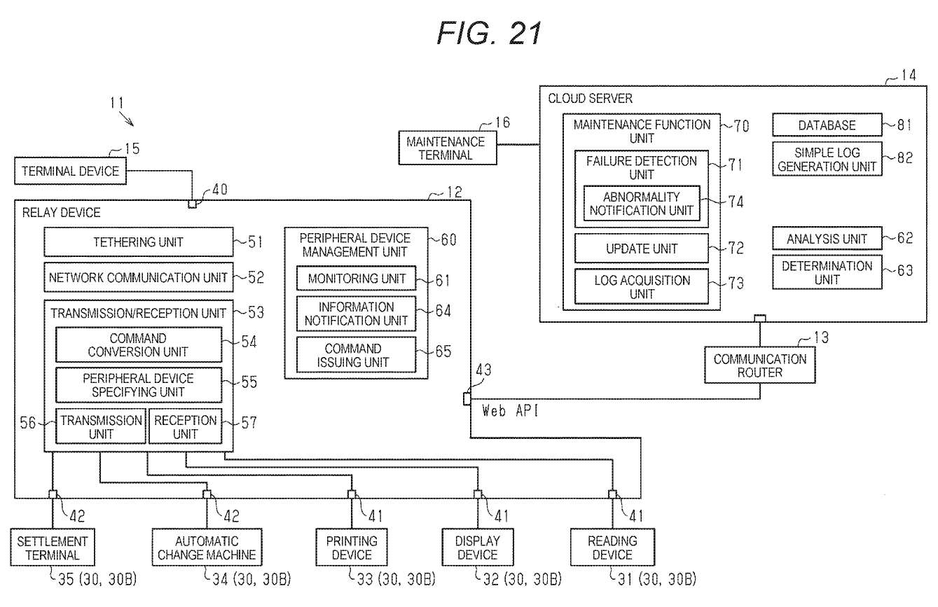

Next, a POS system 11 according to a third embodiment will be described with reference to FIGS. 21 to 23. In the third embodiment, the cloud server 14 includes an analysis unit 62 and performs a command analysis process. The relay device 12 only extracts and saves analysis target information to be analyzed by monitoring the request information and the response information transmitted through the transmission/reception unit. The configuration of the third embodiment can be applied to the POS system 11 according to the first embodiment, and can also be applied to the POS system 11 according to the second embodiment.

FIG. 21 illustrates the configuration of the third embodiment applied to the POS system 11 of the command conversion type according to the first embodiment. In the POS system 11 illustrated in FIG. 21, the cloud server 14 communicably connected to the relay device 12 includes the maintenance function unit 70. That is, the cloud server 14 includes the failure detection unit 71, the update unit 72, the log acquisition unit 73, and the abnormality notification unit 74. The cloud server 14 includes an analysis unit 62 and a determination unit 63. Therefore, the relay device 12 does not perform an analysis process of analyzing the analysis target information acquired by the monitoring unit 61. That is, the relay device 12 does not perform a command analysis process on the command included in the analysis target information. Further, the relay device 12 does not perform a determination process of determining the state of the peripheral device 30. However, the relay device 12 includes the monitoring unit 61. The monitoring unit 61 monitors the request information and the response information transmitted between the first port 40 and the second ports 41, 42 to acquire the analysis target information to be analyzed among the request information and the response information.

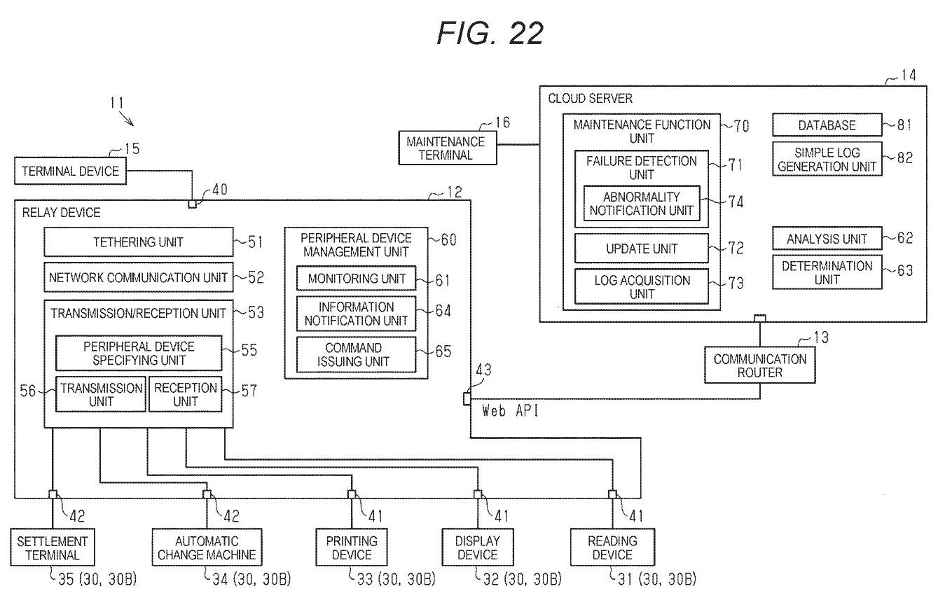

FIG. 22 illustrates the configuration of the third embodiment applied to the POS system 11 of the driver control type according to the second embodiment. In the POS system 11 illustrated in FIG. 22, similarly to the configuration illustrated in FIG. 21, the cloud server 14 communicably connected to the relay device 12 includes the maintenance function unit 70. That is, the cloud server 14 includes the failure detection unit 71, the update unit 72, the log acquisition unit 73, and the abnormality notification unit 74. The cloud server 14 includes an analysis unit 62 and a determination unit 63. Therefore, the relay device 12 does not perform an analysis process of analyzing the analysis target information acquired by the monitoring unit 61. That is, the relay device 12 does not perform a command analysis process on the command included in the analysis target information. Further, the relay device 12 does not perform a determination process of determining the state of the peripheral device 30. However, the relay device 12 includes the monitoring unit 61. The monitoring unit 61 monitors the request information and the response information transmitted between the first port 40 and the second ports 41, 42 to acquire the analysis target information to be analyzed among the request information and the response information.

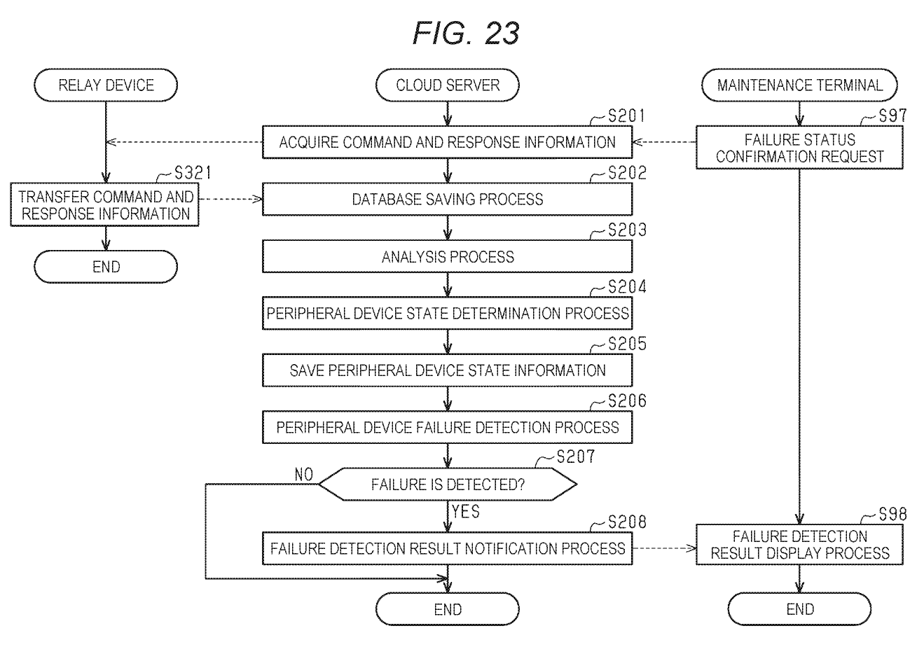

Next, a state determination / failure detection process in the POS system 11 according to the third embodiment will be described with reference to FIG. 23. For example, it is assumed that when a failure occurs in the POS system 11, the content of the failure is checked at a call center, or a maintenance person such as a field engineer at a repair center checks the content of the failure by telephone or chat. The call center or the repair center checks the content of the failure of the POS system 11 while operating the maintenance terminal 16, for example. In the third embodiment, the analysis target information acquired by the monitoring unit 61 during the accounting process is saved in the storage unit 21 in the relay device 12. The analysis unit 62 and the determination unit 63 are provided in the cloud server 14. The analysis of the analysis target information by the analysis unit 62 and the determination based on the analysis result by the determination unit 63 are performed at the timing when the analysis target information is acquired from the cloud server 14 to the relay device 12.

In step S97, the maintenance terminal 16 executes a failure status confirmation request. The maintenance person executes the failure status confirmation request by selecting a failure status confirmation button displayed on the display screen of the maintenance terminal 16 by operating the input unit.

In step S201, the cloud server 14 acquires a command and response information. In this process, the cloud server 14 requests the relay device 12 to transfer a command and response information. The cloud server 14 may acquire the command and the response information from the relay device 12 using a web API.

In step S321, the relay device 12 transfers the command and the response information. In this process, the relay device 12 transfers the command and the response information to the cloud server 14. This transfer may include transfer when the cloud server 14 acquires the command and the response information from the relay device 12 using the web API.

In step S202, the cloud server 14 executes a database saving process. In this process, the cloud server 14 saves the command and the response information acquired from the relay device 12 in the database 81.

In step S203, the cloud server 14 executes an analysis process. In this process, the cloud server 14 executes an analysis process of analyzing the command and the response information saved in the database 81. Specifically, the analysis unit 62 (see FIGS. 21 and 22) in the cloud server 14 analyzes the command and the response information. The analysis unit 62 analyzes response information and a command described in a common command language (for example, an ePOS command or an OPOS command), but the content of the analysis is basically the same as in the first embodiment and the second embodiment.

In step S204, the cloud server 14 executes a peripheral device state determination process. In this process, the cloud server 14 determines the state (status) of the peripheral device 30 based on the analysis result of the analysis unit 62. Specifically, the determination unit 63 (see FIGS. 21 and 22) in the cloud server 14 determines the state of the peripheral device 30 based on the analysis result of the analysis unit 62.

In step S205, the cloud server 14 saves the peripheral device state information. In this process, the cloud server 14 saves the state information (status information) of the peripheral device 30, which is the determination result of the determination unit 63, in the database 81.

In step S206, the cloud server 14 executes a peripheral device failure detection process. In this process, the cloud server 14 executes a failure detection process for detecting a failure of the peripheral device 30. Specifically, the failure detection unit 71 in the cloud server 14 executes the failure detection process. The failure detection unit 71 executes a failure detection process for detecting a failure of the peripheral device 30 based on the analysis information or the state information in the database 81. For example, if failure detection process based on the state information is executed, if there are abnormality states of a plurality of stages including the three stages of mild, moderate, and severe, the failure detection unit 71 detects an abnormality that is severe or higher as a failure as an example. If the failure detection unit 71 executes the failure detection process based on the analysis information, the failure detection unit 71 also detects an abnormality corresponding to severe or higher as a failure. A configuration may be adopted in which the maintenance person can appropriately set which stage of abnormality is regarded as a failure.

In step S207, the cloud server 14 determines whether a failure has been detected. More specifically, the cloud server 14 determines whether a failure has been detected as the result of the failure detection process by the failure detection unit 71. If a failure is detected, the cloud server 14 proceeds to step S208. If no failure is detected, the cloud server 14 ends the state determination / failure detection process.

In step S208, the cloud server 14 executes a failure detection result notification process. In this process, the cloud server 14 notifies the maintenance terminal 16 of a failure detection result indicating that a failure has been detected. Specifically, the abnormality notification unit 74 in the cloud server 14 notifies the maintenance terminal 16 of a failure detection result indicating that a failure has been detected.

In step S98, the maintenance terminal 16 executes a failure detection result display process. In this process, the maintenance terminal 16 causes the display unit to display the failure detection result received from the cloud server 14. Even if the result of the failure detection process indicates that there is no failure, the display unit of the maintenance terminal 16 may be caused to display that there is no failure. In addition, the display unit of the maintenance terminal 16 may be caused to display that an abnormality lower than the level of the failure is detected.

In this way, by operating the failure status confirmation button at the call center or the repair center, the maintenance person can confirm the presence or absence of a failure of the POS system 11, the specification of the peripheral device 30 when there is a failure, the failure status, and the like. This can quickly specify the cause of the occurrence of the failure of the POS system 11, so that the subsequent recovery operation can be performed smoothly. In addition, even when the maintenance person does not check the failure status, if the failure detection unit 71 in the cloud server 14 detects a failure, the failure detection result is displayed on the display unit of the maintenance terminal 16 by the abnormality notification unit 74. Therefore, the occurrence of a failure of the POS system 11 can be found at an early stage, and the specification of the peripheral device 30 that causes the failure and the failure status can be confirmed, so that an accurate recovery operation can be started at an early stage. Therefore, it is possible to reduce the required recovery time, which is required for the recovery of the POS system 11.

By the cloud server 14 and the maintenance terminal 16 executing the process illustrated in FIG. 12 in the same manner as in the first embodiment, the cloud server 14 can generate a simple log in response to an order from the maintenance terminal 16. In the present embodiment, upon receiving a simple log generation order from the maintenance terminal 16, the cloud server 14 completes the processes of step S201, step S321, and step S202 to step S205 in FIG. 23, and then executes the simple log generation process based on the analysis information or state information saved in the database.

In addition, it is possible to cause the relay device 12 to perform the maintenance process of the printing device 33 by remote control from the maintenance terminal 16. Specifically, performed are the detailed log acquisition process illustrated in FIG. 13 and the firmware update process of the printing device 33 illustrated in FIG. 14. More specifically, the relay device 12, the cloud server 14, and the maintenance terminal 16 can acquire the detailed log information on the printing device 33 by remote control by executing the detailed log acquisition process illustrated in FIG. 13. In addition, the relay device 12, the cloud server 14, and the maintenance terminal 16 can update the firmware of the printing device 33 by remote control by executing the firmware update process of the printing device 33 illustrated in FIG. 14.

Therefore, according to the POS system 11 according to the third embodiment, the effects (1-1) to (1-18) in the POS system 11 of the first embodiment and the effect (2-1) in the POS system 11 of the second embodiment are similarly obtained.

The above embodiment may be modified as the following modifications. Further, an appropriate combination of the above described embodiment and the following modifications can be used as another modification, and an appropriate combination of the following modifications can be used as another modification.

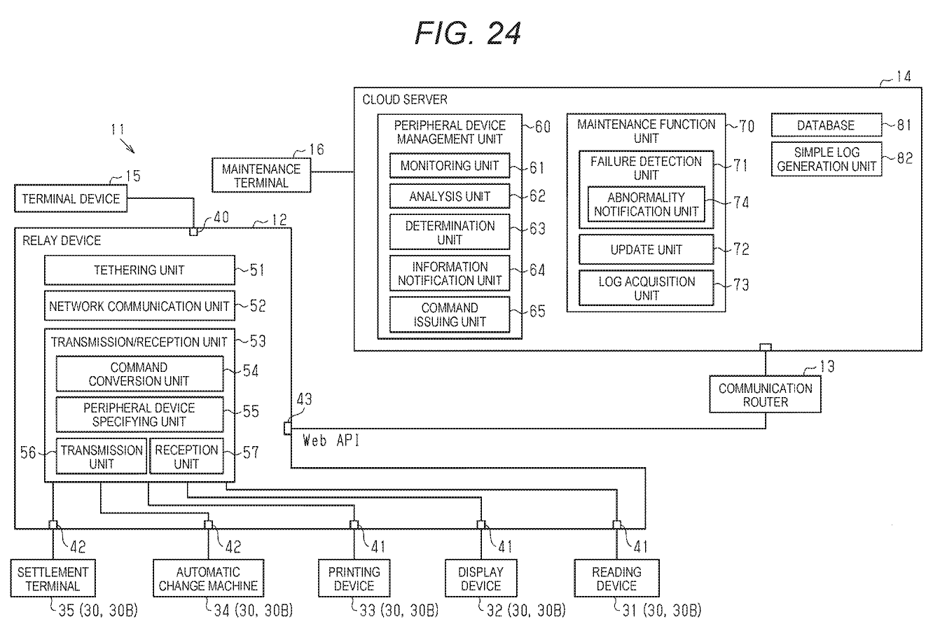

The POS system 11 of the command conversion type is not limited to the configuration of the first embodiment or the third embodiment. For example, as illustrated in FIG. 24, the cloud server 14 communicably connected to the relay device 12 may include the peripheral device management unit 60 and the maintenance function unit 70. In the modification illustrated in FIG. 24, the relay device 12 includes a transmission/reception unit 53. The relay device 12 performs a command conversion process by the command conversion unit 54. For example, the cloud server 14 implements the function of the monitoring unit 61 by a web API. The monitoring unit 61 monitors the request information and the response information transmitted through the transmission/reception unit 53 to acquire the analysis target information among the request information and the response information. The information notification unit 64 functions not only as a notification function but also as an information transfer unit for transferring (transmitting) analysis target information. Through the web API of the cloud server 14, the information notification unit 64 (information transfer unit) transfers the analysis target information acquired by the monitoring unit 61 from the relay device 12 to the cloud server 14. The analysis unit 62 analyzes the analysis target information acquired by the monitoring unit 61. The determination unit 63 determines the state of the peripheral device 30 based on the analysis result of the analysis unit 62. The cloud server 14 saves the analysis information and the state information in the database 81.

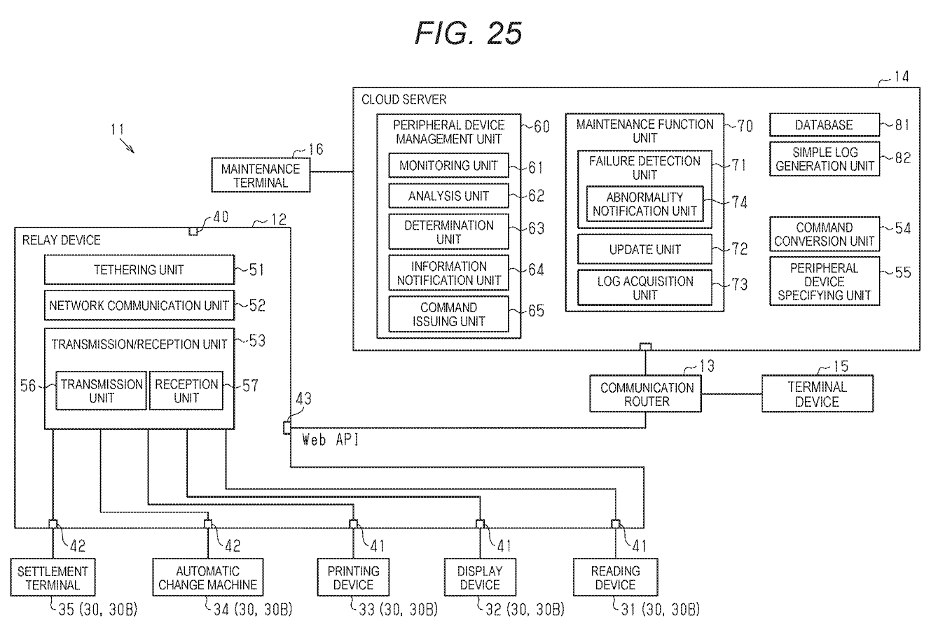

As illustrated in FIG. 25, the POS system 11 of the command conversion type may be configured such that the cloud server 14 illustrated in FIG. 24 further includes the command conversion unit 54 and the peripheral device specifying unit 55. The terminal device 15 may be communicably connected to the relay device 12 and the cloud server 14 by wired communication or wireless communication via the communication router 13. Similarly to the configuration illustrated in FIG. 25, the monitoring unit 61 monitors the request information and the response information transmitted through the transmission/reception unit 53 to acquire the analysis target information among the request information and the response information. For example, the analysis target information is all of the request information and the response information. The command conversion unit 54 in the cloud server 14 saves the request information on the common command acquired by the monitoring unit 61 for analysis from the relay device 12 to the cloud server 14 through the web API of the cloud server 14, and returns the request information to the relay device 12 after converting the common command into a unique command. The command conversion unit 54 in the cloud server 14 converts the response information described in the unique command language acquired by the monitoring unit 61 from the relay device 12 to the cloud server 14 by the web API of the cloud server 14 from a unique command to a common command, and then saves the response information for analysis. After the response information converted into the common command language is transferred to the relay device 12, the transmission/reception unit 53 of the relay device 12 transmits the response information to the terminal device 15. The analysis unit 62 in the cloud server 14 analyzes the request information and the response information temporarily saved in the cloud server 14 as analysis target information. The determination unit 63 determines the state of the peripheral device 30 based on the analysis result of the analysis unit 62. The information notification unit 64, which is an example of a notification unit, notifies the maintenance terminal 16 of the state of the peripheral device 30 based on the state information. At this time, the determination unit 63 may determine the abnormality state in a plurality of stages, including mild, moderate, and severe, to notify the maintenance terminal 16 of the abnormality state in a plurality of stages. The cloud server 14 saves at least one of the analysis information and the state information in the database 81 to accumulate data for generating a simple log.

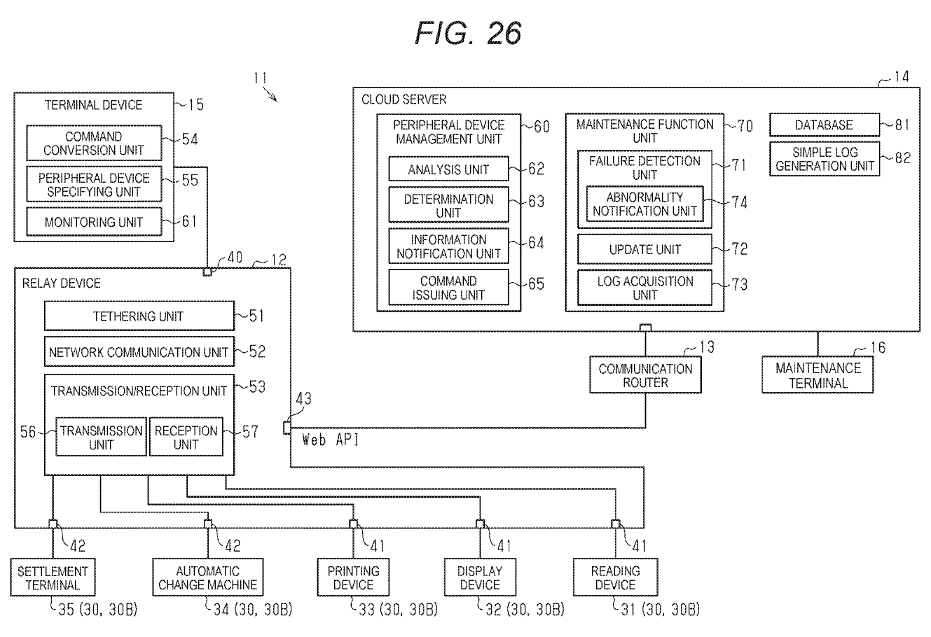

As illustrated in FIG. 26, adopted may be a configuration obtained by moving the command conversion unit 54 and the peripheral device specifying unit 55 from the cloud server 14 to the terminal device 15 in the configuration of the modification illustrated in FIG. 25. The monitoring unit 61 may be provided in the relay device 12 or the cloud server 14, or may be provided in the terminal device 15 together with the command conversion unit 54 as illustrated in FIG. 26. If the monitoring unit 61 acquires the analysis target information described in the common command language, it is not necessary to perform an unnecessary transfer process or the like in the same terminal device 15 as the command conversion unit 54 that converts the response information from a unique command to a common command, and thus the analysis target information can be acquired efficiently. In the modification illustrated in FIG. 24, the monitoring unit 61 may be provided in the transmission/reception unit 53 together with the command conversion unit 54.

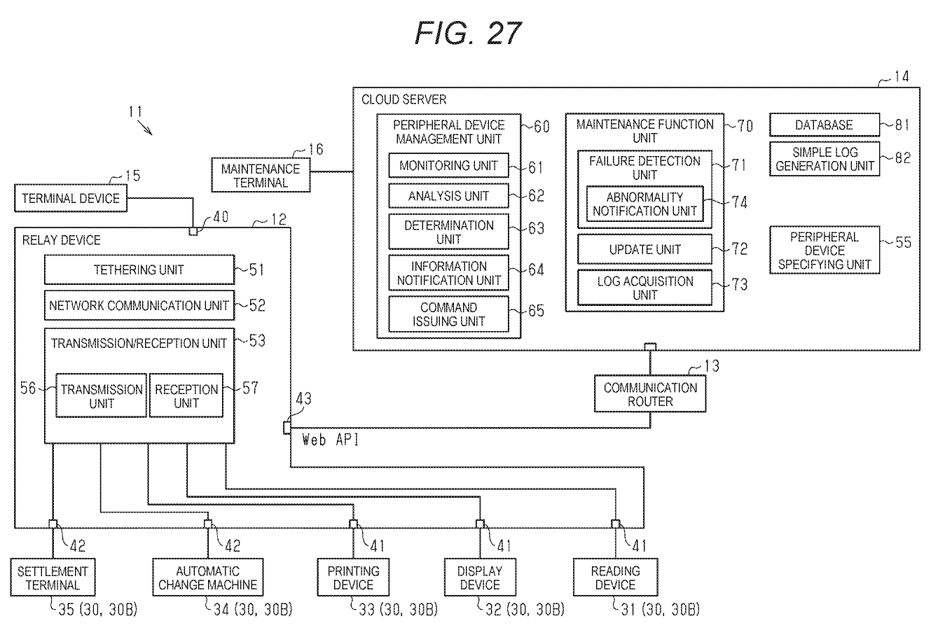

The POS system 11 of the driver control type is not limited to the configuration of the second embodiment or the third embodiment. For example, as illustrated in FIG. 27, the cloud server 14 communicably connected to the relay device 12 may include the peripheral device management unit 60 and the maintenance function unit 70. The configuration of this modification can obtain substantially the same effects as those of the modification illustrated in FIGS. 24 and 25. In the peripheral device specifying unit 55 in the cloud server 14, the monitoring unit 61, the analysis unit 62, the determination unit 63, the failure detection unit 71, the update unit 72, the log acquisition unit 73, and the like may be used to specify the peripheral device 30.

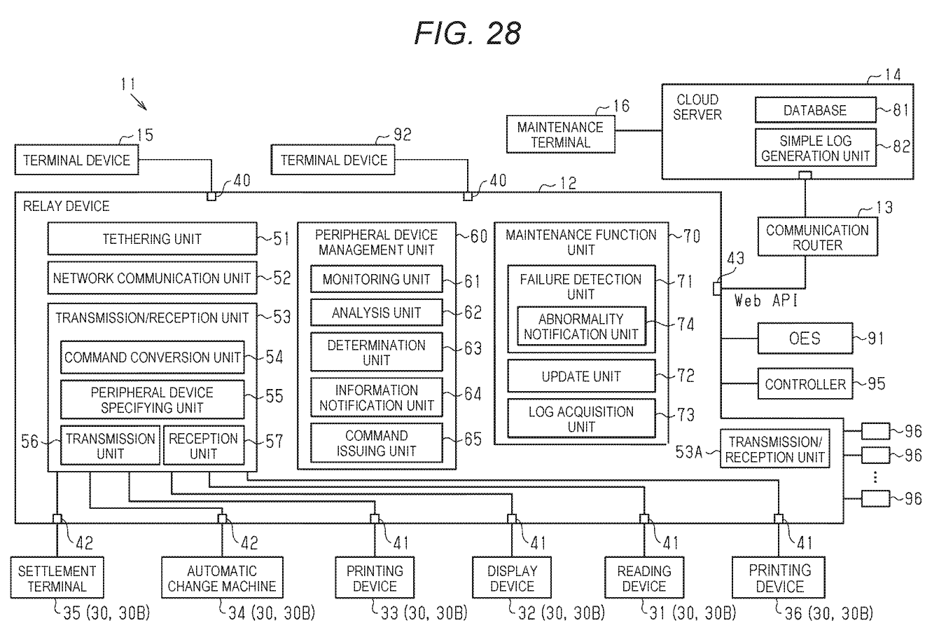

As illustrated in FIG. 28, the POS system 11 may include an order entry system (OES). The order entry system is a mechanism in which when a menu item and a quantity are input to the reading device 31 such as a handy terminal on the spot of taking an order, the order passes by printing order information from a printing device 36 arranged in a manufacturing area such as a kitchen. At the time of settlement, the accounting process can be quickly performed simply by inputting or reading the number of a slip registered at the time of order. In the example illustrated in FIG. 28, in addition to the terminal device 15 for the accounting process and the peripheral device 30, an order entry system 91 (OES) and a terminal device 92 for an order process are connected to the relay device 12. A transmission/reception unit 53A for the order process may be provided in the relay device 12 separately from the transmission/reception unit 53 for the accounting process, so that communication between the terminal device 15 for the accounting process and the peripheral device 30 and communication between the terminal device 92 for the order process and the peripheral device 30 (for example, the printing device 36) can be achieved simultaneously.

The relay device 12 may also serve as the order entry system 91 by incorporating the order entry system 91 in the relay device 12. In this case, a transmission/reception unit included in the order entry system 91 may be used as the transmission/reception unit 53A. FIG. 28 illustrates only one reading device 31, but the reading device 31 for the accounting process and the reading device 31 for the order are connected to the relay device 12. The analysis unit 62 analyzes the analysis target information for the accounting process and the analysis target information for the order process transmitted to each of the transmission/reception units 53, 53A. The determination unit 63 determines the state of the peripheral device 30 for the accounting process and the state of the peripheral device 30 for the order process based on the analysis result of the analysis unit 62. The failure detection unit 71 executes a failure detection process for detecting a failure of the peripheral device 30 based on at least one of the analysis information and the state information. The state information as the determination result of the determination unit 63 is notified from the information notification unit 64 to the maintenance terminal 16 via the cloud server 14. A failure detection result when a failure is detected is notified from the abnormality notification unit 74 to the maintenance terminal 16 via the cloud server 14. The cloud server 14 can be operated from the maintenance terminal 16 to generate a simple log of the peripheral device 30 for the order process. In addition, by remote control from the maintenance terminal 16, it is possible to cause the command issuing unit 65 to issue a maintenance command to acquire detailed log information from the peripheral device 30 for the order process (for example, the printing device 36) or update firmware of the peripheral device 30 for the order process (for example, the printing device 36). Furthermore, one or more peripheral devices 96 of a manufacturing system (kitchen system) disposed in a manufacturing area such as a kitchen and a controller 95 for controlling the one or more peripheral devices 96 may be connected to the relay device 12. The controller 95 controls the one or more peripheral devices 96 of the manufacturing system. The relay device 12 may further include one transmission/reception unit 53A for performing communication between the peripheral devices 96 of the manufacturing system and the controller 95. The transmission/reception unit 53A has basically the same configuration as the transmission/reception unit 53 according to the first embodiment or the transmission/reception unit 53 according to the second embodiment. In communication between the terminal device 92 for the order process and the peripheral device 30 for the order process, a common command exists in a part of the transmission path depending on the command conversion type or the driver control type. Similarly, in the communication between the controller 95 and the peripheral device 96 of the manufacturing system, a common command exists in a part of the transmission path depending on the command conversion type or the driver control type. The monitoring unit 61 monitors the request information and the response information transmitted from each of the transmission/reception units 53, 53A to acquire the analysis target information including the common command from the information group. The determination unit 63 also determines the state of the peripheral device 96 of the manufacturing system based on the analysis result obtained by the analysis unit 62 analyzing the analysis target information. The failure detection unit 71 also detects a failure of the peripheral device 96 of the manufacturing system. The simple log generation unit 82 can also generate a simple log of the peripheral device 96 of the manufacturing system in response to an order from the maintenance terminal 16. Further, by issuing a log acquisition command to the peripheral device 96 of the manufacturing system by remote control from the maintenance terminal 16, a detailed log can be acquired from the peripheral device 96 of the manufacturing system. Further, by issuing an update command by remote control from the maintenance terminal 16 the firmware of the peripheral device 96 of the manufacturing system can be updated.

In FIG. 28, the POS system for the order entry system and the POS system of the manufacturing system are combined via one relay device 12 constituting the POS system 11 for the accounting process, but these POS systems may be configured separately. For example, the POS system 11 for the order process is configured by connecting the terminal device 92 for the order process, the reading device 31 for the order process, and the printing device 36 for the order process to the relay device 12 connected to the order entry system 91. In this case, the relay device 12 constituting the POS system 11 for the accounting process and the relay device 12 constituting the POS system 11 for the order process may be connected via the order entry system 91 to adopt a double-line relay device system in which the order process and the accounting process are linked. Further, the relay device 12 constituting the POS system 11 for the manufacturing system and the relay device 12 constituting the POS system 11 for the order process may be connected via the controller 95 to adopt a three-line relay device system in which the order process, the accounting process, and the manufacturing system management are linked. In the case of a kitchen system, examples of the peripheral device 96 of the manufacturing system include a blast chiller, a shock freezer, a refrigerator for business use, a convention oven, a steam convention oven, an ice maker, and a gas stove for business use. As the store, the present disclosure can be applied to a restaurant such as a family restaurant chain, a pub chain, or a restaurant department of a hotel, but may be applied to a small restaurant or the like that is not in the form of chain store. The terminal device 92 for the order process and the reading device 31 such as a handy terminal may be wireless or wired. The POS system 11 of the manufacturing store is not limited to a POS system 11 for a restaurant, and may be a POS system 11 for a store that manufactures commodities or provides services in the order of orders and performs an accounting process when the commodities are completed or the provision of the services is completed. For example, the POS system 11 may be for a hospital, a financial institution, or the like.

In the POS systems 11 according to the first to third embodiments and the modifications, the relay device 12 may include the database 81 and the simple log generation unit 82. For example, in a store adopting a send-back maintenance service, a maintenance person on the store side may access the relay device 12 from the maintenance terminal 16 via a local area network (LAN) in the store to acquire a simple log. In this case, the maintenance person on the store side may access the relay device 12 by remote control from the maintenance terminal 16 to perform the detailed log acquisition process of the printing device 33 or the firmware update process of the printing device 33. The failure detection result may be directly notified from the relay device 12 to the maintenance terminal 16.

The time for executing the determination process by the determination unit 63 and the failure detection process by the failure detection unit 71 is not limited to the time at which one accounting process is completed. The determination process and the failure detection process may be executed one or more times during one accounting process, or the determination process and the failure detection process may be executed every plurality of accounting processes. The determination process and the failure detection process may be executed at different times.

The POS system 11 of each embodiment and each modification may include an information transmission unit (information transfer unit) for the purpose of transmitting (transferring) information separately from the information notification unit 64. In this case, the information transmission unit is provided in the relay device 12 or the cloud server 14, and transfers at least one type of information among analysis target information, analysis information, and state information from the relay device 12 to the cloud server 14.

The analysis unit 62 may analyze at least response information among request information and response information. For example, the analysis unit 62 may analyze only the response information.

In each of the embodiments and the modifications, the analysis of the analysis target information and the state determination are performed for all the peripheral devices 30 connected to the relay device 12, but the analysis and the state determination may be performed only for some specific peripheral devices 30. For example, the analysis and the state determination may be performed only on the printing device 33, the automatic change machine 34, and the settlement terminal 35. Further, the analysis and the state determination may be performed only on the printing device 33.

In the embodiments described above, the command issuing unit 65 issues a forced termination command during the log acquisition process or the firmware update process, but may issue the forced termination command only for the purpose of forced termination. In this case, the maintenance request may be a forced termination request, and the maintenance process may be a forced termination process. The command issuing unit 65 may issue a restart command. In this case, the maintenance request may be a restart request, and the maintenance process may be a restart process. The restart command belongs to one of the forced termination commands in this specification. The command issuing unit 65 may issue another maintenance command in response to another maintenance request.

In addition to or instead of notifying the cloud server 14 or the maintenance terminal 16 of an abnormality of the peripheral device 30, the display unit of the device constituting the POS system may be caused to display the content of the abnormality. For example, by switching the POS system 11 to a maintenance mode, the content of the abnormality based on the analysis result or the determination result may be displayed on the display device 32 or the terminal device 15. In addition, by activating a maintenance application in the terminal device 15, the terminal device 15 may be caused to display the abnormality content of the peripheral device 30 for confirmation. According to these configurations, since the abnormality content can be confirmed at the site where the POS system 11 is present, the failure content can be appropriately reported to the operator. In addition, the maintenance person on the store side can perform recovery work or the like while checking the abnormality content on the display unit on site, which achieves early recovery.

The server is not limited to the cloud server 14, and may be a server managed by a store. The server may also be a server provided to the store by the vendor of the POS system 11 or the manufacturer of the peripheral device 30, the relay device 12, or the terminal device 15.

The present disclosure may be applied to a POS system 11 using a control method that does not use a common command. In this case, the state determination of the peripheral device 30, the failure detection process, the generation of the simple log, and the like may be performed based on the analysis result obtained by analyzing the analysis target information including the unique command described in the unique command language for each peripheral device 30. In addition, the detailed log acquisition process from the printing device 33 and the firmware update process of the printing device 33 may be performed.

The POS system 11 is not limited to the accounting process performed by the store clerk. The POS system 11 may be applied to an unmanned reception terminal, a self-service checkout machine, or a KIOSK terminal (small autonomous information terminal). In these cases, the peripheral devices for various stores may be a business printer, a document scanner, a digital signage, a surveillance camera, lights, a patrol robot, an air conditioner, or the like. Furthermore, the POS system 11 may be an order entry for catering and a kitchen printer. In this case, the peripheral device may be a related robot or a related system such as a cooking tool. The POS system 11 may be applied to a system related to a bank check scanner. That is, the relay device 12 may be applied to each POS system described above.

### Definitions

The expression "at least one" used in the present specification means "one or more" of desired options. For example, the expression "at least one" used in the present specification refers to "only one option" or "both of two options" when the number of options is two. As another example, the expression "at least one" used in the present specification refers to "only one option" or "a combination of any two or more options" when the number of options is three or more.

### Technical Ideas

Hereinafter, the technical ideas grasped from the embodiments and modifications described above will be described together with effects.
[1] A relay device for POS system is a relay device for POS system configured to relay communication between a terminal device configured to execute an accounting process and one or more peripheral devices. The relay device includes: a transmission unit configured to transmit request information to any of the peripheral devices; a reception unit configured to receive response information from any of the peripheral devices; an analysis unit configured to analyze analysis target information to be analyzed among the request information and the response information; and a determination unit configured to determine a state of any of the peripheral devices based on an analysis result of the analysis unit. According to this configuration, the relay device determines the state of the peripheral device from the analysis result of the analysis target information among the request information and the response information. The determination information acquired from the relay device is useful for recovery from a failure of the peripheral device. This can shorten the failure recovery time of the POS system as compared with before.
[2] In the relay device for POS system according to [1], if the state of any of the peripheral devices is abnormal, the determination unit may determine the abnormal state in a plurality of stages according to a difference in degree of importance. According to this configuration, the state of abnormality of the peripheral device can be determined for each degree of importance. This can shorten the failure recovery time of the POS system as compared with before. For example, it is possible to reduce a delay in recovery response due to overlooking of an important determination result, and waste due to excessive response to an unimportant determination result.
[3] The relay device for POS system according to [1] or [2] may include a notification unit configured to notify a server of a determination result of a determination unit via a network. According to this configuration, since the server on the network is notified of the result determination by the determination unit, the state of the peripheral devices can be known even from a remote location away from the POS system. It is also possible to know the state of the peripheral devices from a terminal connected to the server. This can shorten the failure recovery time of the POS system as compared with before.
[4] In the relay device for POS system according to any one of [1] to [3], the command included in the request information may be a common command. The command included in the response information may be a unique command specific to any of the peripheral devices. The relay device may include: a command conversion unit configured to convert the common command into the unique command before transmitting the request information to any of the peripheral devices and convert the response information from any of the peripheral devices from the unique command into the common command; a first port configured to allow the terminal device to be connected; a second port configured to allow the peripheral devices to be connected; and a monitoring unit configured to monitor an information group transmitted between the first port and the second port to acquire the analysis target information including the common command from the information group. The analysis unit may analyze the analysis target information including the common command acquired by the monitoring unit. According to this configuration, in the POS system of the command conversion type, the analysis unit analyzes the common command. Therefore, the analysis processing time can be reduced as compared with a configuration in which a unique command specific to the peripheral device is analyzed.
[5] In the relay device for POS system according to any one of [1] to [3], the relay device may be adopted in a POS system of a driver control type in which the peripheral devices are controlled by a predetermined operating system installed in the terminal device and a common command from a driver operating on the predetermined operating system. The relay device may include: a first port configured to allow the terminal device to be connected; a second port configured to allow any of the peripheral devices to be connected; and a monitoring unit configured to monitor an information group transmitted between the first port and the second port to acquire the analysis target information including the common command from the information group. The analysis unit may analyze the analysis target information including the common command acquired by the monitoring unit. According to this configuration, the analysis unit may analyze the common command by adopting the relay device in the POS system of the driver control type. Therefore, the analysis processing time can be shortened compared to a configuration in which analysis target information including a unique command is analyzed by the POS system using a unique command specific to the peripheral device.
[6] The relay device for POS system according to any one of [1] to [5] may include: a communication unit configured to be communicably connected to a server or a maintenance terminal; a failure detection unit configured to detect a failure of any of the peripheral devices based on the analysis result of the analysis unit or a determination result of the determination unit; and an abnormality notification unit configured to, when the failure detection unit detects a failure, notify the server or the maintenance terminal of an abnormality of a corresponding peripheral device. According to this configuration, since the server or the maintenance terminal is notified of the abnormality in which a failure has occurred in the peripheral device via the network, it is possible to know the failure of the peripheral device at an early stage. Therefore, it is possible to quickly cope with the failure of the peripheral device.
[7] In the relay device for POS system according to any one of [1] to [6], at least one of the peripheral devices may be a printing device. The relay device may include: a command issuing unit configured to issue a command that can be interpreted by the printing device; and a maintenance function unit configured to, upon receiving a maintenance request, cause the command issuing unit to issue a maintenance command to cause the printing device to perform a maintenance process. According to this configuration, it is possible to send the maintenance request to the relay device, thereby causing the printing device to perform the maintenance process. Therefore, it is possible to cause the printing device to perform the maintenance process, thereby leading to early recovery from the failure or resolving the failure of the peripheral device without going to the store.
[8] In the relay device for POS system according to any one of [1] to [6], at least one of the peripheral devices may be a printing device. The relay device may include: a command issuing unit configured to issue a command that can be interpreted by the printing device; and an update unit configured to, upon receiving an update request, cause the command issuing unit to issue an update command for causing the printing device to update firmware. According to this configuration, it is possible to send the update request to the relay device, thereby updating the firmware of the printing device connected to the relay device. For example, by sending an update request to the relay device by remote control, it is possible to update the firmware of the printing device without going to the store.
[9] In the relay device for POS system according to any one of [1] to [6], at least one of the peripheral devices may be a printing device. The relay device may include: a command issuing unit configured to issue a command that can be interpreted by the printing device; and a log acquisition unit configured to, upon receiving a log acquisition request, cause the command issuing unit to issue a log acquisition command for causing the printing device to acquire log information. According to this configuration, it is possible to send a log acquisition request to the relay device to acquire log information on the printing device. For example, by sending a log acquisition request to the relay device by remote control, it is possible to acquire the log information on the printing device without going to the store.
[10] In the relay device for POS system according to [7], upon receiving a forced termination request for the printing device as the maintenance request, the maintenance function unit may cause the command issuing unit to issue a forced termination command for forcibly terminating the printing device. According to this configuration, the printing device can be forcibly terminated by sending the forced termination request to the relay device as the maintenance request. For example, by sending a forced termination request to the relay device by remote control, it is possible to forcibly terminate the printing device without going to the store. Therefore, the printing device can be maintained without going to the store.
[11] A POS system includes: a relay device configured to relay between a terminal device configured to execute an accounting process and one or more peripheral devices; and a server configured to be connected to the relay device via a network. The relay device includes: a transmission unit configured to transmit request information to any of the peripheral devices; and a reception unit configured to receive response information from any of the peripheral devices. The relay device or the server includes: an analysis unit configured to analyze analysis target information to be analyzed among the request information and the response information; and a determination unit configured to determine a state of any of the peripheral devices based on an analysis result of the analysis unit.

According to this configuration, the determination information acquired from the relay device or the server is useful for specifying a failure of the peripheral device. This can shorten the failure recovery time of the POS system as compared with before. For example, by providing the analysis unit and the determination unit in the server, the storage unit (memory) of the relay device can be saved. In addition, the server often has abundant memory, and has a higher performance of the CPU and the like. If the analysis unit and the determination unit are provided in the server, the command analysis and the determination can be performed in detail and deeply, and thus a particularly remarkable effect can be obtained.
[12] In the POS system according to , the relay device may include the analysis unit. According to this configuration, the command acquired by the relay device can be analyzed in situ. It is not necessary to transfer a command outside the relay device for analysis. Therefore, it is easy to determine the state of the peripheral device based on the analysis result with little delay.
[13] The POS system according to may include: an abnormality detection unit configured to detect an abnormality of any of the peripheral devices based on the analysis result of the analysis unit or a determination result of the determination unit; and an abnormality notification unit configured to, when the abnormality detection unit detects the abnormality, notify a maintenance terminal connected to the server of information indicating that a corresponding peripheral device is abnormal. The abnormality detection unit may be provided in the relay device or the server. The abnormality notification unit may be provided in the relay device or the server. According to this configuration, when an abnormality of the peripheral device is detected, the maintenance terminal connected to the server is notified of information indicating that the peripheral device is abnormal, which allows the maintenance person or the like to know the abnormality of the POS system even from a remote location. By providing the abnormality notification unit in the relay device, the notification of the abnormality notification unit may be configured such that the server acquires the detection result indicating the abnormality from the relay device through the web API, so that the relay device notifies the server of the information indicating the abnormality.
[14] In the POS system according to , at least one of the peripheral devices may be a printing device. The POS system may include: a command issuing unit configured to issue a command; and a maintenance function unit configured to, upon receiving a maintenance request for the printing device, cause the command issuing unit to issue a maintenance command for the printing device to cause the printing device to perform a maintenance process according to the maintenance request. The command issuing unit may be included in the relay device or the server. The maintenance function unit may be included in the relay device or the server. According to this configuration, by sending a maintenance request for the printing device to the relay device or the server, it is possible to cause the printing device to perform the maintenance process by remote control.
[15] In a server for, in a POS system including a terminal device configured to execute an accounting process and one or more peripheral devices, being communicably connected to a relay device configured to relay the terminal device and the peripheral devices, the relay device includes: a transmission unit configured to transmit request information to any of the peripheral devices; and a reception unit configured to receive response information from any of the peripheral devices. The server includes: an analysis unit configured to analyze analysis target information to be analyzed among the request information and the response information; and a determination unit configured to determine a state of any of the peripheral devices based on an analysis result of the analysis unit. According to this configuration, the relay device determines the state of the peripheral device from the analysis result of the analysis target information among the request information and the response information. The determination information acquired from the relay device is useful for specifying a failure of the peripheral device. This can shorten the failure recovery time of the POS system as compared with before.
[16] The server for POS system according to may be connected to a maintenance terminal via a network. The server may accumulate the analysis result of the analysis unit or a determination result of the determination unit as a database. The server may include a simple log generation unit configured to, upon receiving a simple log generation request from the maintenance terminal, generate a simple log of any of the peripheral devices based on the database. According to this configuration, by sending a simple log generation request from the maintenance terminal to the server, it is possible to acquire a simple log of the peripheral device. Therefore, it is easy to specify the cause of the failure of the POS system.
[17] A maintenance method for POS system is a maintenance method for POS system for maintaining one or more peripheral devices in a POS system including a terminal device configured to execute an accounting process and the peripheral devices. The POS system includes a relay device configured to relay the terminal device and the peripheral devices. The relay device includes: a transmission unit configured to transmit request information to any of the peripheral devices; and a reception unit configured to receive response information from any of the peripheral devices. The method includes: analyzing analysis target information to be analyzed among the request information and the response information; acquiring maintenance information available for maintenance of the peripheral devices based on an analysis result of the analysis target information; and causing an output unit of a device configured to communicate with the relay device to output the maintenance information. According to this method, the maintenance information available for maintenance of the peripheral device is output to the output unit of the device capable of communicating with the relay device. Therefore, by using the maintenance information, for example, it is easy to specify the failure of the peripheral device, and the failure recovery time of the POS system is shortened compared with before. For example, by outputting the maintenance information from the output unit of a device located at a remote location away from the POS system, it is easy to specify the cause of the failure of the peripheral device at an early stage without going to the store.
[18] A maintenance method for POS system is a maintenance method for a POS system including a terminal device configured to execute an accounting process and one or more peripheral devices. The POS system includes a relay device configured to relay the terminal device and the peripheral devices. The relay device includes: a communication unit configured to be communicably connected to a server or a maintenance terminal; a transmission unit configured to transmit request information to any of the peripheral devices; and a reception unit configured to receive response information from any of the peripheral devices. The method includes: analyzing analysis target information to be analyzed among the request information and the response information; detecting an abnormality of any of the peripheral devices based on an analysis result of the analysis target information; and, upon detecting the abnormality, notifying the server or the maintenance terminal of information indicating that the peripheral device is abnormal. According to this method, since the maintenance person or the like is notified of the abnormality of the peripheral device via the server or the maintenance terminal, the maintenance person or the like can know the abnormality occurring in the peripheral device at an early stage. Therefore, since the recovery response at the time of occurrence of a failure or the like can be started early, the POS system can be easily recovered earlier than before.
[19] A maintenance method for POS system is a maintenance method for a POS system including a terminal device configured to execute an accounting process and one or more peripheral devices. The POS system includes a relay device configured to relay the terminal device and the peripheral devices. The relay device includes: a communication unit configured to be communicably connected to a server or a maintenance terminal; a transmission unit configured to transmit request information to any of the peripheral devices; and a reception unit configured to receive response information from any of the peripheral devices. At least one of the peripheral devices is a printing device. The maintenance method includes: upon detecting an abnormality of the printing device based on an analysis result obtained by analyzing analysis target information to be analyzed among the request information and the response information, notifying the server or the maintenance terminal of information indicating an abnormality; upon receiving a maintenance request for the printing device from the server or the maintenance terminal, issuing a maintenance command corresponding to the maintenance request and transmitting the maintenance command to the printing device; the printing device performing a maintenance process instructed by the maintenance command; and, upon receiving outcome information on the maintenance process or completion information on the maintenance process from the printing device, sending the outcome information or the completion information to the server or the maintenance terminal. According to this method, it is possible to know an abnormality of the printing device even from a remote location away from the POS system, and to cause the printing device to perform the maintenance process by remote control. Examples of the maintenance request include a log acquisition request, a firmware update request, and a forced termination request. Examples of the maintenance command include a log acquisition command, a firmware update command, and a forced termination command. Examples of the outcome information include log information. The completion information includes an update completion notification, a forced termination completion notification, and the like.

What is claimed is:

1. A relay device for POS system configured to relay communication between a terminal device configured to execute an accounting process and one or more peripheral devices, the relay device comprising:
a transmission unit configured to transmit request information to any of the peripheral devices;
a reception unit configured to receive response information from any of the peripheral devices;
an analysis unit configured to analyze analysis target information to be analyzed among the request information and the response information; and
a determination unit configured to determine a state of any of the peripheral devices based on an analysis result of the analysis unit.

2. The relay device for POS system according to claim 1, wherein
if the state of any of the peripheral devices is abnormal, the determination unit determines the abnormal state in a plurality of stages according to a difference in degree of importance.

3. The relay device for POS system according to claim 1, comprising:
a notification unit configured to notify a server of a determination result of a determination unit via a network.

4. The relay device for POS system according to claim 1, wherein
the command included in the request information is a common command,
the command included in the response information is a unique command specific to any of the peripheral devices,
the relay device comprises:
a command conversion unit configured to convert the common command into the unique command before transmitting the request information to any of the peripheral devices and convert the response information from any of the peripheral devices from the unique command into the common command;
a first port configured to allow the terminal device to be connected;
a second port configured to allow the peripheral devices to be connected; and
a monitoring unit configured to monitor an information group transmitted between the first port and the second port to acquire the analysis target information including the common command from the information group, and
the analysis unit analyzes the analysis target information including the common command acquired by the monitoring unit.

5. The relay device for POS system according to claim 1, wherein
the relay device is adopted in a POS system of a driver control type in which the peripheral devices are controlled by a predetermined operating system installed in the terminal device and a common command from a driver operating on the predetermined operating system,
the relay device comprises:
a first port configured to allow the terminal device to be connected;
a second port configured to allow any of the peripheral devices to be connected; and
a monitoring unit configured to monitor an information group transmitted between the first port and the second port to acquire the analysis target information including the common command from the information group, and
the analysis unit analyzes the analysis target information including the common command acquired by the monitoring unit.

6. The relay device for POS system according to claim 1, comprising:
a communication unit configured to be communicably connected to a server or a maintenance terminal;
a failure detection unit configured to detect a failure of any of the peripheral devices based on the analysis result of the analysis unit or a determination result of the determination unit; and
an abnormality notification unit configured to, when the failure detection unit detects a failure, notify the server or the maintenance terminal of an abnormality of a corresponding peripheral device.

7. The relay device for POS system according to claim 1, wherein
at least one of the peripheral devices is a printing device, and
the relay device comprises:
a command issuing unit configured to issue a command that can be interpreted by the printing device; and
a maintenance function unit configured to, upon receiving a maintenance request, cause the command issuing unit to issue a maintenance command to cause the printing device to perform a maintenance process.

8. The relay device for POS system according to claim 1, wherein
at least one of the peripheral devices is a printing device, and
the relay device comprises:
a command issuing unit configured to issue a command that can be interpreted by the printing device; and
an update unit configured to, upon receiving an update request, cause the command issuing unit to issue an update command for causing the printing device to update firmware.

9. The relay device for POS system according to claim 1, wherein
at least one of the peripheral devices is a printing device, and
the relay device comprises:
a command issuing unit configured to issue a command that can be interpreted by the printing device; and
a log acquisition unit configured to, upon receiving a log acquisition request, cause the command issuing unit to issue a log acquisition command for causing the printing device to acquire log information.

10. The relay device for POS system according to claim 7, wherein
upon receiving a forced termination request for the printing device as the maintenance request, the maintenance function unit causes the command issuing unit to issue a forced termination command for forcibly terminating the printing device.

11. A POS system comprising: a relay device configured to relay between a terminal device configured to execute an accounting process and one or more peripheral devices; and a server configured to be connected to the relay device via a network, wherein
the relay device includes:
a transmission unit configured to transmit request information to any of the peripheral devices; and
a reception unit configured to receive response information from any of the peripheral devices, and
the relay device or the server includes:
an analysis unit configured to analyze analysis target information to be analyzed among the request information and the response information; and
a determination unit configured to determine a state of any of the peripheral devices based on an analysis result of the analysis unit.

12. The POS system according to claim 11, wherein
the relay device includes the analysis unit.

13. The POS system according to claim 11, comprising:
an abnormality detection unit configured to detect an abnormality of any of the peripheral devices based on the analysis result of the analysis unit or a determination result of the determination unit; and
an abnormality notification unit configured to, when the abnormality detection unit detects the abnormality, notify a maintenance terminal connected to the server of information indicating that a corresponding peripheral device is abnormal, wherein
the abnormality detection unit is provided in the relay device or the server, and
the abnormality notification unit is provided in the relay device or the server.

14. The POS system according to claim 11, wherein
at least one of the peripheral devices is a printing device,
the POS system comprises:
a command issuing unit configured to issue a command; and
a maintenance function unit configured to, upon receiving a maintenance request for the printing device, cause the command issuing unit to issue a maintenance command for the printing device to cause the printing device to perform a maintenance process according to the maintenance request,
the command issuing unit is included in the relay device or the server, and
the maintenance function unit is included in the relay device or the server.

15. A server for, in a POS system including a terminal device configured to execute an accounting process and one or more peripheral devices, being communicably connected to a relay device configured to relay the terminal device and the peripheral devices, wherein
the relay device includes:
a transmission unit configured to transmit request information to any of the peripheral devices; and
a reception unit configured to receive response information from any of the peripheral devices, and
the server comprises:
an analysis unit configured to analyze analysis target information to be analyzed among the request information and the response information; and
a determination unit configured to determine a state of any of the peripheral devices based on an analysis result of the analysis unit.

16. The server for POS system according to claim 15, wherein
the server is connected to a maintenance terminal via a network,
the server accumulates the analysis result of the analysis unit or a determination result of the determination unit as a database, and
the server comprises a simple log generation unit configured to, upon receiving a simple log generation request from the maintenance terminal, generate a simple log of any of the peripheral devices based on the database.
